(19) United States
(12) Patent Application Publication
(10) Pub. No.: US 2026/0233394 A1
(43) Pub. Date: Aug. 13, 2026

(54) MOBILE ROBOTIC DEVICES AND SYSTEMS

(71) Applicant: The Trustees of Princeton University, Princeton, NJ (US)

(72) Inventors: Robert SHI, Princeton, NJ (US); Jaime Fernández FISAC, Princeton, NJ (US)

(73) Assignee: The Trustees of Princeton University, Princeton, NJ (US)

(21) Appl. No.: 19/156,513

(22) PCT Filed: Feb. 16, 2024
(86) PCT No.: PCT/US2024/016079

§ 371 Date: Aug. 14, 2025

Related U.S. Application Data
(60) Provisional application No. 63/446,460, filed on Feb. 17, 2023.

(51) Int. Cl. B25J 9/16; B25J 5/00; B25J 9/10; B25J 19/00; B62D 57/028

(52) U.S. Cl. CPC B25J 9/1664; B25J 5/007; B25J 9/104; B25J 19/0008; B25J 19/005; B62D 57/028

(57) ABSTRACT

Various devices and systems related to mobile robotic devices may be provided, along with improved techniques for controlling such mobile robotic devices. Specific configurations of mobile robotic devices, including systems comprising multiple robotic devices that can be coupled together. The devices may include at least one processing unit configured to control positioning and/or rotation of each of the plurality of contact elements in a specific manner, that generally includes encoding discrete dynamic modes with contact statuses for each of the plurality of contact elements, and constructing appropriate equations of motion and constraint equations, and when discrete mode transitions arise, updating discrete mode encodings and applying continuous state reset mappings. Additionally, devices including pulleys and belts may be provided, where the belts may be looped around idlers that are coupled to an intermediate rotary element. Desirable configurations of such devices include differentials, speed reducers, and torque vectoring mechanisms.

### CROSS-REFERENCE TO RELATED APPLICATIONS

The present application claims priority to U.S. Provisional Patent Application No. 63/446,460 Filed Feb. 17, 2023, the contents of which are incorporated by reference herein in its entirety.

### TECHNICAL FIELD

The present disclosure is drawn to the field of mobile robotic devices and systems.

### BACKGROUND

Last-mile delivery is the final phase of package delivery, involving the transport of a package from a warehouse (e.g., at the manufacturing site, or at a distribution center) to the customer's doorstep. Last-mile delivery, in aggregate, is the most expensive and time-consuming part of the shipping process.

Aerial drones are an existing solution to the last-mile delivery problem. However, issues related to airspace restrictions, noise, and capacity concerns have limited adoption to experimental suburban delivery and extreme cases related to the delivery of crucial medical supplies to inaccessible regions. The disclosed ground-based system is largely unaffected by such concerns. The disclosed approach may be implemented to supplement aerial systems. Ground-based deliveries may occur simultaneously with aerial deliveries. In addition, aerial drones may potentially be deployed and retrieved from instances of the disclosed ground-based system to improve effective delivery range. The disclosed ground-based system may also serve as a communication link for other robots, such as aerial drones.

Existing sidewalk delivery robots from various providers have aimed to address the last-mile delivery problem. These robots drive on sidewalks, generally have 4-6 wheels, and carry the payload in a compartment within the robot hull akin to a mobile package locker. These solutions can traverse curbs but struggle with traversing stairs, limiting application to highly accessible environments and necessitating that the customer be available to retrieve the payload directly from the robot. In addition, the fixed storage compartment limits the size of payloads that may be transported. Payload storage in a body cavity increases package safety and security; however, the impact of such a payload securing method is diminished in the case of “curbside-to-doorstep”. This is due to the fact that the disclosed device transports the package between the delivery van and the customer's doorstep, in a curbside-to-doorstep delivery approach. In curbside-to-doorstep delivery, a shorter distance is traversed, and the disclosed device operates in more secure locations such as residential sidewalks and private lawns. This is in comparison to existing delivery robots that aim to address the entire last mile of delivery by traveling longer routes and navigating environments such as crosswalks and high-foot-traffic areas.

Existing commercial human support robots are largely limited by their inability to traverse stairs. This limits the workspace of existing human support robots to a single floor or environments which include elevators or ramps.

### BRIEF SUMMARY

Various deficiencies in the prior art are addressed below by the disclosed compositions of matter and techniques.

In various aspects, a mobile robotic device may be provided. The mobile robotic device may include a main body operably coupled to a plurality of contact elements. Each contact element may be a wheel, track, or foot. The mobile robotic device may include at least one processing unit. The processing unit(s) may be configured to control positioning and/or rotation of each of the plurality of contact elements. The processing unit(s) may be configured to, collectively, perform various tasks. Such tasks may include processing perception and odometry data. The tasks may include encoding hybrid dynamic modes with contact statuses for each of the plurality of contact elements. The tasks may include constructing a dynamical model for each discrete mode at runtime, and, when discrete mode transitions arise, updating discrete mode encodings and applying continuous state reset mappings The tasks may include simulating possible hybrid robot trajectories. The tasks may include controlling the robot to follow a planned trajectory.

As utilized in this document, the term “hybrid” specifically pertains to the existing domain of hybrid systems theory, which is applied to the operational framework of robotic mechanisms. A “hybrid system”, in this context, is characterized by its capacity to operate with continuous dynamics while being capable of executing discrete jumps between distinct system dynamics. These jumps are designated as “hybrid transitions”, representing pivotal shifts in the discrete mode of the system that can alter how the robot's continuous state evolves. The “continuous state” of a robot is characterized by the positions and angles of its joints, providing a detailed description of its physical configuration. Conversely, the “discrete mode” captures the robot's current contact configuration, and is defined by a unique set of system dynamics that dictate how the robot's continuous state evolves. The “hybrid state” of the robot captures the full spectrum of its operational capabilities by combining continuous states and discrete modes.

In the disclosed device, discrete modes may be encoded by a vector of the type of interaction of each contact element. Essentially, the discrete mode encoding represents whether each contact element is touching another surface or object, and, if so, the type of contact.

Discrete mode transitions occur in response to changes in how these contact bodies interact with their surroundings. Such changes include entering contact, leaving contact, or changing contact type (for example, transitioning from a stationary (static) contact to a sliding (kinetic) contact).

The main body may have a left side and a right side. Each side may include a body frame. Each side may include a first wheel, which may be operably coupled to the body frame. Each first wheel may be one of the plurality of contact elements. Each side may include a first motor. The first motor may be operably coupled to the first wheel. The main body may include a plurality of upper legs. Each upper leg may be removably coupled to the body frame of the left side or the right side. Each upper leg may include an upper leg structural member having a first end and a second end. The upper leg structural member may be rotatably coupled to the body frame at the first end. Each upper leg may include a second motor and a third motor operably coupled to the upper leg structural member. The main body may include a plurality of lower legs. Each lower leg may be coupled to one of the plurality of upper legs. Each lower leg may include a lower leg structural member having a first end and a second end. The first end of the lower leg structural member may be rotatably coupled to the second end of the upper leg structural member to form a knee joint. Each lower leg may include a passive second wheel rotatably coupled to the first end of the lower leg structural member. Each passive second wheel may be one of the plurality of contact elements. A foot or smaller passive wheel may be coupled to the second end of the lower leg structural member. Each foot or smaller passive wheel may be one of the plurality of contact elements. Each first motor may be configured to independently control the rotation of its first wheel (which may be around a same first axis). Each second motor may be configured to independently control a rotational position of its upper leg structural member relative to the body frame. Each third motor may be configured to independently control a rotational position of its lower leg structural member relative to its corresponding upper leg.

The first wheel and the passive second wheel may be coplanar. A first track may run between the first wheel and the passive second wheel. The second end of the lower leg may include a passive third wheel (which may be, e. g,. a smaller passive wheel), and the main body may include a second track attached between the passive third wheel and a wheel that is on a same rotational axis and parallel to the passive second wheel at the knee joint. The parallel wheels at the knee joint may be coupled such that the first track and second track can be driven simultaneously.

Each upper leg may include a first belt and pulley coupling the second motor to its upper leg structural member. Each upper leg may include a second belt and pulley coupling the third motor to its lower leg structural member.

A distance between the first wheel on the left side of the main body and the first wheel on the right side of the main body may be adjustable. A drive shaft of each third motor may extend through an opening at the first end of each upper leg structural member to a pulley that drives the rotation of the lower leg structural member.

The mobile robotic device may include circuitry coupled to the main body. The circuitry may connect one or more of the processing unit(s), a memory, and a non-transitory computer-readable storage medium. The mobile robotic device may include a battery removably coupled to the mobile robotic device.

The mobile robotic device may be configured to operate in a variety of contact configurations. The variety of contact configurations may consist of any subset of its wheels and feet in contact with a ground surface, another robot surface, or an environment surface. Each unique arrangement of contact configurations and contact types constitutes a discrete mode. The variety of contact configurations may consist of any subset of its wheels, tracks, and/or feet in contact with a ground surface, another robot surface, and/or an environment surface. In certain embodiments, no more than six contact elements may be in contact with a ground surface at any point in time. In certain embodiments, more than six contact elements may be in contact with a ground surface at any point in time.

The mobile robotic device may be able to dynamically transition from a first contact configuration to a second contact configuration. Dynamically transitioning indicates the robot may enter and leave contacts (e.g., transition between discrete modes) during active, energetic motions. This is contrary to non-dynamic transitions, which require stopping or slowing down to perform hybrid transitions.

The mobile robotic device may include one or more inertial stabilizers coupled to the main body and independently actuated by an additional motor. In certain aspects, at least one first wheel may be configured to operate, while not in contact with a ground surface, as an inertial stabilizer.

The mobile robotic device may include one or more sensors coupled to the main body. The mobile robotic device may include one or more manipulators coupled to the main body. The main body may define an attachment point. The attachment point may be configured to receive a payload. The attachment point may be configured to attach to another robot.

The mobile robotic device may include a central actuator operably coupled to the main body. As used herein, the central actuator refers to an actuator that provides torque to multiple joints. The central actuator may include a combustion engine or an electric motor. The central actuator may be located onboard the mobile robotic device (for example, rather than being attached at the attachment point, or coupled on top of the body frame, the central actuator may be disposed within the main body of the robot). The central actuator may be configured to charge an onboard battery by back-driving an electric motor.

The mobile robotic device may include a differential configured to split torque to multiple joints. The mobile robotic device may include a continuously variable transmission (CVT) or torque vectoring device operably coupled to wheels, legs, and tracks to control the rotation speed and rotation direction of joints.

In various aspects, a mobile robotic system may be provided. Such a system may include a plurality of embodiments of the mobile robotic devices as disclosed herein, mechanically coupled together (e.g., a body frame of one robot may be coupled, either directly or indirectly, to a body frame of an adjacent robot). A body frame of a first robotic device is dynamically couplable to a body frame of an adjacent robotic device. A body frame of a first robotic device may be separated from a body of an adjacent mobile robot device by at least a predetermined minimum distance (i.e., a distance d>0). The mobile robotic system may include a payload, a sensor, a manipulator, or a combination thereof, coupled to the main body of at least one of the plurality of mobile robotic devices.

Each mobile robot device in the system may be linked to a common actuator via a mechanic interface on a common surface. The common actuator may be disposed external to each mobile robot device, and each mobile robot device may be driven by the common central actuator. The common actuator may be configured to charge at least one battery while the mobile robotic system is in transit.

The mobile robotic system may include a differential configured to split torque to multiple robots.

In various aspects, a system for controlling a mobile robot may be provided. The system may include at least one processing unit configured to control the position and/or rotation of each of a plurality of contact elements. The plurality of contact elements may include a first contact element and a second contact element. The at least one processing unit may be configured to, collectively, perform various tasks. Such tasks may include processing perception and odometry data. The tasks may include encoding discrete modes with contact statuses and types for each of the plurality of contact elements. The tasks may include encoding hybrid dynamic modes of contact statuses for each of the plurality of contact elements. The tasks may include determining at least one specific time at which guard conditions are met, resulting in transitions between discrete mode encodings. The tasks may include constructing dynamical models for hybrid dynamic modes of the system at runtime by procedurally integrating appropriate equations of motion and kinodynamic constraints into forward dynamics. The tasks may include simulating possible future robot hybrid trajectories. The tasks may include planning a trajectory based on the hybrid dynamical models. The tasks may include controlling the robot to follow a planned trajectory by causing at least the first contact element to spatially move relative to the second contact element based on the trajectory.

In various aspects, a method for controlling a robot utilizing a hybrid dynamical simulation algorithm may be provided. The method may include (a) receiving inputs. The inputs may include a robot continuous state at time t. The inputs may include a robot discrete mode at time t. The inputs may include a robot hybrid state at time t. The robot hybrid state at time t may include a discrete mode at time t and a continuous state at time t. The inputs may include robot physical parameters. The inputs may include the aggregate effect of generalized forces and external physical forces acting on the robot's continuous states torque at time t. The inputs may include a stepsize (dt). The inputs may include information relating to an environment surrounding the robot. The information relating to the environment may include, e.g., a map of an environment surrounding the robot. The map may include geometric structures and mechanical properties of the environment.

The robot's continuous state is updated through the numerical integration—often referred to as “flowing”—of the equations of motion corresponding to its current discrete mode. These discrete modes are prone to abrupt transitions, or “jumps”, propelling the robot into different discrete modes that may be governed by distinct equations of motion. Such transitions are dictated by the robot's environmental interactions. For instance, a hybrid transition occurs when the robot's foot contacts the ground, altering the dynamics due to the new contact scenario. Recognizing and accurately modeling these discrete transitions is paramount for a thorough understanding of the robot's behavior as it navigates and interacts with various elements of its surroundings.

The method may include (b) utilizing inputs to construct constrained equations of motion during runtime for the hybrid state of a robot (e.g., the robot hybrid dynamics). The method may include (c) numerically integrating the equations of motion (“flow”) within the discrete robot mode to obtain a robot's continuous state at a subsequent timestep: t+dt. The method may include (d) determining if a discrete mode transition (“jump”) occurred between time t and t+dt by checking for guard conditions occurring between the robot's continuous state at time t and the robot's continuous state at time t+dt.

As used herein, the term “guard condition”, as defined in hybrid systems theory, refers to a set of circumstances wherein a hybrid system may undergo a discrete mode transition, or “jump”. For instance, when the minimum distance between a contact element of the robot and an external surface becomes zero, contact occurs, which triggers a discrete mode transition and an immediate update in the overall hybrid state (both in the discrete contact status and in continuous state variables such as velocity, whose value may suffer an instantaneous “reset” caused by impact).

If no guard condition arises, the method further comprises accepting the continuous robot state at time t+dt and the discrete mode at time t as jointly forming a next hybrid state in a simulated trajectory at time t+dt. In this case, the discrete mode would remain H(t) since no discrete mode transitions occurred.

If a guard condition arises, the method may include various additional computations. Such additional steps may include using a root-finding algorithm to find the first time (t+a*, where 0<a*<dt) at which the guard condition occurred. The additional computations may include generating an updated robot hybrid state (the discrete mode may be in any appropriate form, such as a vector) after the “jump” by appropriately switching the discrete mode and performing any necessary continuous state resets (e.g., according to a reset map).

The additional computations may include repeating steps (b)-(d) with dt=dt−a*, the updated environment at time t+a*, and the updated robot hybrid state comprising the robot's continuous state at an intermediate time t+a* and the robot's discrete state after the discrete transition at time t+a*. The additional computations may include, once no guard conditions arise, accepting the robot hybrid state at time t+a* (which may include accepting that hybrid state as the next hybrid state in the trajectory, or as an intermediate hybrid state to compute the hybrid state at t+dt). As will be understood, accepting the hybrid state at time t+a* may be an alternative to the method previously discussed, and such acceptance would break the uniformity of stepsizes (e.g., the stepsizes would no longer keep to a fixed value of dt).

The method may be used to control a robot based on the computed hybrid states in the trajectory.

Multiple types of guard conditions are possible, which cause discrete mode transitions (sometimes referred to as “jumps”). Guard conditions may arise in continuous time between simulation steps. The hybrid dynamical simulation algorithm performs checks for multiple types of guard conditions based on the conditions surrounding the contact elements. If a force acting on a contact body tangent to a contacting surface, edge, or corner crosses a static friction threshold, the method may include using a root-finding algorithm to find the first time (t+a*) when the friction of the contact body equals the static friction threshold. Time t+a*, in this case, denotes the transition between static and sliding friction contact. If a contact element enters contact with a surface, edge, or point, the method may include using a root-finding algorithm to backtrack to the first time (t+a*) when a contact element makes contact with a surface, edge, or corner. If a force perpendicular to a contact interface—such as a the surface, edge, or corner—transitions from being a repelling force to an attractive force, or if a contact interface (such as an contact point) leaves a boundary, the method may include using a root-finding algorithm to backtrack to the first time (t+a*) when the force perpendicular to the contact interface becomes zero or when the contact interface exits contact with a boundary (such as a surface, edge, or point boundary).

The hybrid dynamical simulation algorithm may additionally include methods to recognize and prevent Zeno behavior, defined as an infinite number of discrete mode transitions occurring within a finite time interval.

The method may include computing one or more Jacobians of the equations of motion at runtime. The method may include controlling the robot based on computed continuous states and Jacobians. In some embodiments, controlling the robot may include determining the appropriate commands to be sent to the robot's actuators (e.g., motors) with the aim of executing a physical robot trajectory that follows (or closely follows) the desired trajectory plan computed with the aid of the runtime simulator.

In various aspects, a mechanism may be provided. The mechanism may include a plurality of pulleys operably coupled by one or more belts. The plurality of pulleys may include a first pulley and a second pulley. The mechanism may include an intermediate rotary element, with at least one shaft and at least one idler such that at least one of the one or more belts is passed over the at least one shaft at least once.

The intermediate rotary element may be configured to transmit torque to subsequent components (such as a first subsequent component). Each pulley may be configured to also transmit torque to subsequent components (e.g., to at least one additional subsequent component).

In certain aspects, the one or more belts may be looped once over one or more of the at least one idler, the first pulley may receive a torque input and split the torque, as a differential, between the second pulley and the intermediate rotary element, such that: (i) the intermediate rotary element rotates in a same direction as the first pulley, and (ii) the second pulley rotates in an opposite direction as the first pulley. As will be understood, in these configurations, the pulley ratio may depend on the radius of the first and second pulley.

In certain aspects, the one or more belts are looped twice over one or more of the at least one idler, the first pulley receives a torque input and rotates (e.g., around a central axis) in a first direction, the intermediate rotary element is rotationally fixed, and the second pulley rotates (e.g., around the central axis) in the first direction. “Rotationally fixed” generally refers to a component that does not rotate (i.e., is “fixed”), or may be oriented in a fixed orientation relative to a surface over which the robot is traveling.

In certain aspects, the one or more belts are looped twice over one or more of the at least one idler, the first pulley is rotationally fixed, the intermediate rotary element receives a torque input, and the second pulley rotates with a reduction ratio and rotation direction dependent on the number of teeth on the first and second pulleys. In certain aspects, the first pulley is rotationally fixed, the second pulley receives a torque input, and the intermediate rotary element rotates with a reduction ratio and rotation direction dependent on the number of teeth on the first and second pulleys.

The one or more belts may be looped one time over one or more of the at least one idler. The one or more belts may be looped twice over one or more of the at least one idler. The one or more belts may be looped more than two times over one or more of the at least one idler. The plurality of pulleys may be on separate axes. The at least one idler may include a plurality of idlers, and the plurality of idlers may be on separate axes.

In various aspects, a system may be provided. The system may include a plurality of embodiments of mechanisms as disclosed herein mechanically coupled together.

In certain aspects, the plurality of mechanisms may include a first differential mechanically coupled to a second differential. A rotary element of the first differential may be coupled to a first pulley of the second differential. A second pulley of the first differential may be coupled to a rotary element of the second differential. Actuators may be configured to control a magnitude and direction of torque at a second pulley of the second differential.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an illustration of a side view of an embodiment of a mobile robotic device.

FIG. 2 is an illustration of the main body of an embodiment of a mobile robotic device.

FIG. 3A is an illustration of a front view of an embodiment of a mobile robotic device.

FIG. 3B is an illustration of a front view of another embodiment of a mobile robotic device.

FIG. 4 is an illustration of a side view of another embodiment of a mobile robotic device.

FIG. 5 is an illustration of a front view of another embodiment of a mobile robotic device.

FIG. 6 is a closeup showing a drive shaft of a motor extending through a leg segment to couple with a pulley.

FIG. 7 is an illustration of a side view of another embodiment of a mobile robotic device.

FIGS. 8 and 9 are illustrations of a side view of embodiments of systems with two robotic devices.

FIGS. 10 and 11 are illustrations of a front view of various embodiments of a mobile robotic device.

FIGS. 12 and 13 are illustrations of a side view of embodiments of systems with two robotic devices.

FIG. 14 is an illustration of an embodiment of a system with two robotic devices.

FIG. 15 is an illustration of an embodiment of a system with two robotic devices configured with a payload platform.

FIGS. 16 and 17 are illustrations of a side view of embodiments of systems with two robotic devices utilizing a central actuator.

FIG. 18 is a simplified flowchart of computing forward dynamics and Jacobians.

FIG. 19 is a flowchart for a single simulation step (x[t]->x[t+dt]).

FIG. 20A is a flowchart of a sequence of steps human delivery of packages.

FIG. 20B is a flowchart of a sequence of steps for delivery of packages utilizing embodiments of a robotic device.

FIG. 21 is an illustration of an embodiment of a robotic device with tracks and a concentric shaft.

FIG. 22 is an illustration of a pulley-based differential for central actuation.

FIG. 23 is a diagram showing torque split between two pulleys.

FIG. 24 is an illustration of a pulley-based speed reducer.

FIG. 25 is a schematic of the speed reducer capable of high reduction ratios.

FIG. 26 is a diagram showing a torque vectoring mechanism composed of two differentials that can adjust the magnitude and direction of torque transmitted to a single output shaft.

FIG. 27 is a schematic of an embodiment of central actuation, whereby a single motor drives multiple outputs, utilizing differentials, clutches, and torque vectoring mechanisms to continuously vary the magnitude and direction of rotation of outputs.

FIG. 28 is a diagram of the pulley-based differential with inputs and output pulleys on separate axes.

FIG. 29 is a schematic of the concentric shafts of the tracked robotic device in FIG. 21.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

To overcome various deficiencies in the prior art, various devices and systems related to mobile robotic devices may be provided, along with improved techniques for controlling such mobile robotic devices. Such devices may include a main body operably coupled to a plurality of contact elements (e.g., a wheel, track, or foot). The devices may include at least one processing unit configured to control positioning and/or rotation of each of the plurality of contact elements, the at least one processing unit configured to, collectively perform various tasks. Such tasks may include processing perception and odometry data. The tasks may include encoding discrete dynamic modes with contact statuses for each of the plurality of contact elements. The tasks may include constructing appropriate equations of motion and constraint equations, and when discrete mode transitions arise, updating discrete mode encodings and applying continuous state reset mappings. Such robotic devices may be coupled together so as to perform various tasks, such as delivering packages.

This disclosure additionally presents devices consisting of pulleys and belts. These belts may be looped around idlers that are coupled to an intermediate rotary element. Some preferred configurations of such devices include differentials, speed reducers, and torque vectoring mechanisms. The torque vectoring mechanism controls both the magnitude and direction of rotary output, utilizing actuators to adjust the distribution of torque input. When arranged in specific configurations, these components facilitate a centralized control mechanism. This setup is characterized by a powerful, high-torque actuator that drives the entire system. The actuator's output, in terms of both the magnitude and direction of the joint torques, is finely adjusted by auxiliary motors that operate at lower torques. This arrangement allows for precise control over the mechanical outputs, enabling compact and modular robotic systems.

Disclosed is a mobile robotic platform. The disclosed devices, systems, and techniques improve upon a broad class of existing products spanning wheeled and legged robots. An important feature of the disclosed approach includes the geometric configuration of links and joints, which enables a fluid combination of legged and wheeled locomotion, as well as modular coupling between two or more identical robot units to achieve extended motion and payload capabilities. A single robot unit can perform bipedal walking and differential drive; two coupled robot units can jointly perform quadrupedal walking and differential drive; three coupled robot units can jointly perform hexapedal walking and differential drive; and so on. The robot and multiple coupled instances of the robot can utilize intermediate modes of locomotion, which include combinations of tracked, wheeled, and legged locomotion to accomplish a wide range of mobility-related tasks.

The disclosed approach describes a mobile platform that can accommodate a variety of sensors that allow the robot to accomplish tasks such as localization and mapping. In addition, a variety of tools and manipulators may be attached to the robot, allowing it to accomplish general tasks such as manipulation actions and other interactions with the environment. The disclosed approach may be capable of traversing flat ground as well as curbs and stairs, making it uniquely suited for applications within buildings and in urban environments. Such applications include general assistive robotics, payload transportation, and physical telepresence.

The disclosed robotic device has applications, inter alia, in transportation, specifically the transportation of kilogram-scale payloads over smooth terrain, rough terrain, and environmental obstacles such as curbs and stairs. In an exemplary embodiment, the disclosed approach can be employed to address the “last 50-foot delivery problem”, which encompasses the final segment of the consumer package delivery process, from the “robot carrier vehicle”, such as a delivery van, to the customer's front doorstep. The envisioned solution utilizes multiple instances of the disclosed approach (robot platform) that originate from the carrier vehicle. The carrier acts as a mobile central hub or mothership from which the robots deliver the packages. Instances of the disclosed invention may exit the carrier at a dispatch location and re-enter the carrier at a separate rendezvous location. This scheme decreases the number of stops required for the carrier and enables simultaneous deliveries, increasing efficiency. Further, robots may enter and exit a moving carrier, eliminating the requirement for stops entirely and further increasing efficiency. For instance, robots may utilize legs to hop in and out of delivery vans.

In separate transportation applications, the envisioned solution may additionally serve as a modular wheel component of the carrier vehicle. The robot may removably couple to the carrier chassis to propel the carrier vehicle. In a centrally actuated configuration, the robots may be driven by torque provided by a central electric motor or engine on the carrier vehicle, in addition to a self-contained power and actuation system on the robot. Upon reaching a delivery stop, the robots may decouple from the chassis to perform the delivery. The robots may recouple with the chassis and propel the carrier to the subsequent stop.

The solutions disclosed herein are capable of traversing stairs and depositing payloads in secure locations such as on a porch or at the top of a staircase. In addition, a single instance of the disclosed approach may be maneuverable due to differential drive with two wheels and pseudo-legged locomotion. As a result, the disclosed system may be well-suited for deployment in areas with various obstacles and moderate-to-high human foot traffic. Further, the disclosed approach may be capable of reaching higher speeds via wheeled travel, opening the potential for operation on residential roads. Configurations may additionally include tracks for traversal of granular and irregular terrains.

The disclosed approach may include configurations where wheels and legs are all capable of continuous rotation, defined as the absence of angular limits of joint positions. Continuous joints and removably coupled legs, wheels, and tracks enable the modular robot to rapidly reconfigure to address terrain traversal and task challenges.

Embodiments of the disclosed invention may secure the payload on an external surface, enabling efficient, possibly fully autonomous, payload coupling and decoupling. Additionally, due to the presence of modular attachment interfaces on the disclosed device, a container module may be attached to a single instance or multiple instances of the disclosed device, to permit increased payload security and safety. A modular attachment interface further enables the disclosed device to attach to and provide propulsion to structures such as a carrier chassis. A modular attachment interface may additionally include mechanical and electrical power transmission interfaces.

Additionally disclosed herein are compact mechanisms, including a differential, speed reducer, and torque vectoring mechanism, which collectively enable central actuation. In the central actuation paradigm, a single actuator drives multiple outputs. The disclosed mechanisms split torque and modulate the magnitude and direction of output torque. This enables a single onboard or external motor to drive the entire system. Central actuation eliminates the need for a dedicated driving motor for each joint, reducing the size, weight, and cost of robotic systems. Additionally, these mechanisms improve modularity as they centralize mechanical torque, similar to how power and processing capabilities are centralized. The mechanisms include gear, shaft, and pulley interfaces, which enable ease of integration and extension. For example, the multiple instances of the differential may be appended or stacked to enable a compact multi-input, multi-output differential system. Further, in the central actuation paradigm, the full torque of a single powerful central actuator may be routed to a single joint, increasing the limits of joint torque compared to traditional approaches where a lower-power motor is dedicated to each joint.

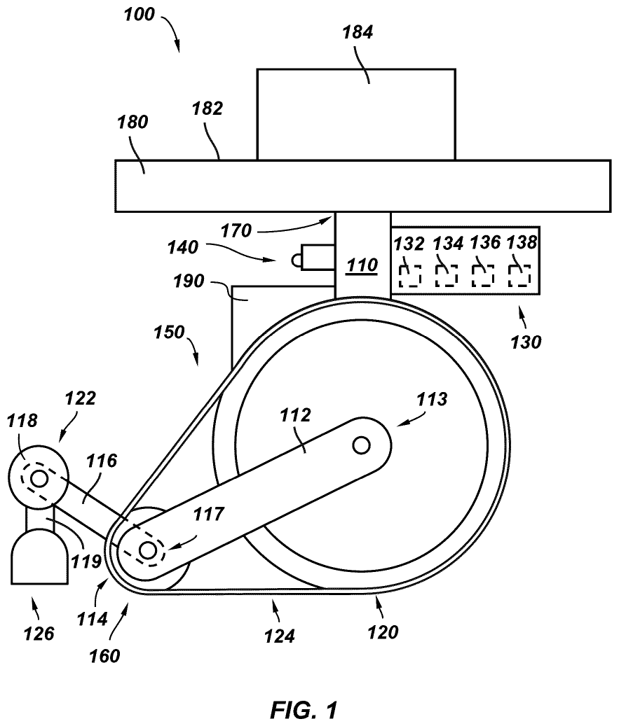

In various aspects, a mobile robotic device may be provided. Referring to FIG. 1, a mobile robotic device (100) may include, e.g., a main body (110) defining a plurality of contact elements (120).

The contact element should be a component that aids in the locomotion of the robotic device. For example, each contact element may be a wheel (122), track (124), or foot (126). There may be any number of contact elements.

Each contact element may be separated by one or more structural elements, which may be referred to as “leg” components. Contact elements that are coupled together via leg components form an individual leg (150). Each mobile robotic device may include two or more legs. Each mobile robotic device may include only two legs (e.g., forming a generally “bipedal” robotic device, similar to a human, with one leg on each “side” of the robotic device).

There may be any number of contact elements in each leg. Preferably, each leg may include at least three contact elements. In some embodiments, each leg includes only three contact elements. For each leg, there may be any number of leg components, although preferably there are N−1 leg components, where N is the number of contact elements. In FIG. 1, there are three leg components—a first leg component (112), a second leg component (116), and a third leg component (119). Each leg component will generally be rotatable relative to other leg components. Each point around which the leg component(s) rotate is considered a knee joint (160).

The first leg component (112) may have an first end (113) and a second end (114). The second leg component (116) may have a first end (117) and a second end (118). The first leg component may be coupled to the main body (110) at the first end (113) of the first leg component. The second end (114) of the first leg component (112) may be coupled to the first end (117) of the second leg component (116). A third leg component (119) may be coupled to the second end (118) of the second leg component (116).

The robotic device may include control circuitry (130) operably coupled to the main body. The control circuitry may include at least one processing unit (132). The term “processing unit” refers generally to any kind of programmable or non-programmable circuitry that is or can be configured to carry out a set of operations. A processing unit may include hardware, software, or a combination thereof. For example, a processing unit may comprise one or more processors and a transitory or non-transitory memory that carries a program which causes the processing unit to perform the respective operations when the program is executed by the one or more processors. Non-limiting examples of such processing units may include one or more digital signal processors (DSPs), reduced instruction set computers (RISC), general-purpose (CISC) processors, microprocessors, gate arrays (e.g., field programmable gate arrays (FPGAs)), programmable logic devices (PLDs), reconfigurable computer fabrics (RCFs), array processors, secure microprocessors, application-specific integrated circuits (ASICs), and/or other digital processing devices. Such digital processors may be contained on a single unitary integrated circuit (IC) die or distributed across multiple components. It will be understood that if more than one processing unit is present, the processing units may be readily configured to, collectively, perform various tasks, as disclosed herein, in various manners.

The control circuitry may include a memory (134) operably coupled to the one or more processing units. The control circuitry may include a non-transitory computer-readable storage device (136) (sometimes referred to as a storage medium) operably coupled to the one or more processing units. The control circuitry may include one or more additional components (138) operably coupled to the one or more processing units. These additional components may include, e.g., an I/O interface, such as a wired and/or wireless interface.

The device may include one or more sensors (140). The one or more sensors may be operably coupled to the one or more processing units.

The at least one processing unit (132) may be configured to control positioning and/or rotation of each of the plurality of contact elements. The at least one processing unit may be configured to, collectively, perform various tasks to control the operation of the robotic device.

Such tasks may include processing data from the sensors, to generate perception and/or odometry information. This may include receiving information in the form of 3D point clouds, video, inertial data, encoder data, global positioning system (GPS) data, and/or map data (which may be, e.g., maps stored locally). In some embodiments, all information from the sensors is stored on a non-transitory computer-readable storage device, and the processing unit(s) then read all necessary information from those storage devices. In some embodiments, sensor data may be sent directly to the processing unit(s), and any non-sensor data (such as maps) may be accessed as needed (e.g., from a local storage device, over a network, etc.).

The term “perception information” generally refers to both classic perception (e.g., object detection and/or classification, object tracking, etc.) as well as predictions of future continuous states or trajectories of external objects. This may include estimations of, e.g., one or more of object positions, object classifications, estimations of free space, lane markings, object trajectory predictions, etc. Estimations of free space may include estimating areas absent of external objects (static and dynamic objects). Estimations of free space may include estimating the roughness of an area (e.g., to determine if the area can be traversed by the robot). Estimations of free space may include determining if an area includes a paved surface.

The term “odometry information” generally refers to the result of estimating the position and posture of the robotic device, which may be on the basis of an output value of a device (a timer, a sensor, a motor, an actuator, etc.). For example, a wheel speed sensor may, e.g., directly measure a rotational speed of a wheel at multiple time points or may measure a voltage of a motor coupled to the wheel, and the processing units(s) may calculate a speed and/or position of the robotic device based on that rotational speed or voltage.

Such tasks may include encoding discrete modes with contact statuses for each of the plurality of contact elements. The enumeration may take any appropriate form. In some embodiments, the enumeration is a value represented in binary as an integer encoding. In some embodiments, the enumeration may be a vector of contact statuses. In some embodiments, the contact status may be a “0” if the contact element is not in contact with a surface, or a “1” if it is. Thus, if a robotic device has six contact elements, the enumeration of discrete modes may be [0,0,0,1,1,1] (or the value “7” represented in binary).

Such tasks may include constructing appropriate equations of motion and constraint equations, and when discrete mode transitions arise, updating discrete mode encodings and applying continuous state reset mappings. This construction of dynamical models for each discrete mode can be done at runtime. This construction at runtime is possible, in part, because the processing unit(s) have access to pre-computed functions that generate the floating-base equations of motion (robot with no contacts) and can construct the constraint equations associated with the discrete mode (e.g., for one foot on the ground, one can constrain the x, y, and z components of the position, velocity, and acceleration of the contact point). This results in the processor generating the equations of motion of the robot.

Other simulation approaches generate the floating base dynamics and apply impulses to simulate contacts. Traditional hybrid systems approaches precompute the equations of motion for all discrete modes and switch between them. As embodiments of the disclosed robotic devices may have over 470 billion discrete modes, the traditional approach is not feasible for the disclosed robotic devices.

Here, the processing unit may numerically integrate the equations of motion to obtain the next continuous state of the robot.

Such tasks may include computing forward dynamics and Jacobians of the system. The processing unit may compute Jacobian(s) of the dynamics with respect to the continuous state and input of the robot. The state Jacobian describes how the current joint angles and velocities affect the dynamics. The input Jacobian describes how the current joint torques (control inputs of the robot) will affect the dynamics. A saltation matrix enables computations of Jacobians through discrete mode transitions. Based on the computed Jacobians, the processing unit may adjust the robot's continuous state and joint torques to get it to move in a desired fashion. The forward simulation rollouts and Jacobian computations enable control algorithms for hybrid robot locomotion. An example of a control algorithm that utilizes forward dynamics and Jacobians is a receding, finite-horizon Iterative Linear Quadratic Regulator.

The tasks of the processing units may include planning a trajectory based on the dynamical models using sampling-based algorithms such as Batched Information Trees (BIT*) or shooting methods enabled by the hybrid dynamical simulator model in which an initial trajectory guess is iteratively refined until boundary and constraint conditions are met. As used herein, planning a trajectory refers to computing a reference trajectory for the robot's motion controller to aim to follow, such that the trajectory is dynamically feasible under the hybrid dynamical model of the robot and additionally satisfies operational constraints such as collision avoidance and approximately optimizes a suitable performance metric encoding desirable properties of the robot's motion such as progress towards the goal location, timeliness, and power efficiency.

The tasks may also include causing one or more contact elements to move (e.g., move spatially) relative to a different contact element based on the trajectory. That is, if the trajectory requires transitioning from driving on two wheels to using a foot to step up a staircase, the tasks may include causing one or more leg components to rotate around a joint, causing at least the foot to move spatially relative to another contact element (such as one of the two wheels the robot was driving on).

The tasks may also include processing sensor information for odometry, localization, and mapping.

The main body may include an attachment point (170). The attachment point may be configured to attach to one or more components, devices, or systems. The attachment point may be configured to couple to another robotic device. The attachment point may be configured to attach to, e.g., a recharging or refueling station. The attachment point may be configured to attach to a latching mechanism on the inside of a vehicle. The attachment point may be configured to attach to a latching mechanism on the outside of a vehicle.

For example, the attachment point may be configured to receive a payload. A payload platform (180) may be attached to the attachment point. The payload platform may have a surface (182) on which a payload (184) may be placed.

In some embodiments, the mobile robotic device may include a battery (190). The battery may be removably coupled to the mobile robotic device.

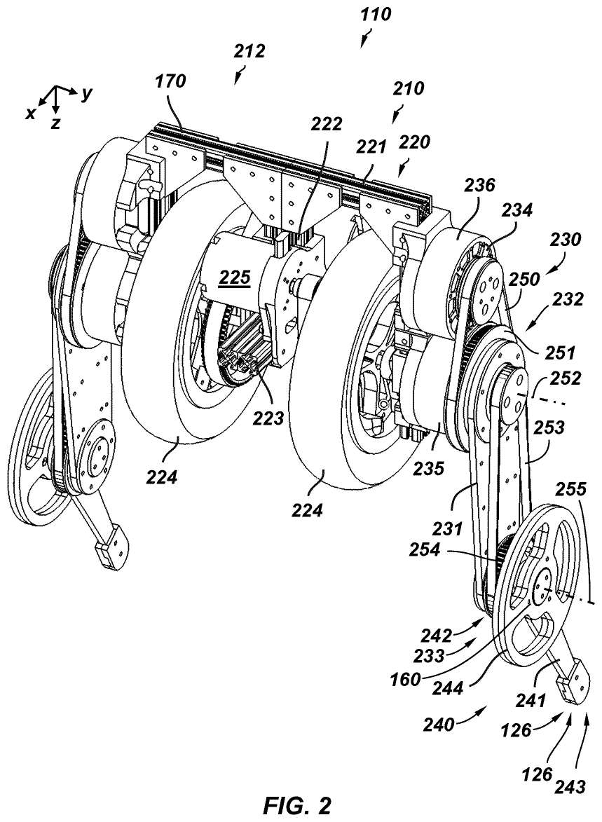

Referring to FIG. 2, one embodiment of a main body (110) can be seen. The main body may have a left side (210) and a right side (212), which may be removably coupled.

Each side may include a body frame (220). In some embodiments, the body frame may include one or more straight structural beams coupled together. In some embodiments, the body frame may include a first beam (221) extending in a first direction (e.g., horizontal, in the y-direction), a second beam (222) extending in a second direction perpendicular to the first direction (e.g., vertical, in the z-direction), and a third beam (223) extending in a third direction perpendicular to both the first and second directions (e.g., in the x-direction). In some embodiments, an attachment point (170) may be defined on the main body, such as by one of the structural beams.

The main body may include a contact element, such as a first wheel (224), operably coupled to the body frame. The main body may include a mechanism for causing the first wheel to rotate, such as a first motor (225), operably coupled to the first wheel, either directly or indirectly (e.g., via gears, etc.) The robotic device may include a plurality of upper leg portions (230). Each upper leg portion may be removably coupled to the body frame of the left side or the right side. Each upper leg portion may include an upper leg structural member (231) having a first end (232) and a second end (233). The upper leg structural member may be rotatably coupled (indirectly) to the body frame at the first end.

Each upper leg portion may include a second motor (234) and a third motor (235) operably coupled to the upper leg structural member. This may include one or more housings (236) disposed around the motor(s), where the housing(s) are attached or otherwise coupled to the upper leg structural member. In some embodiments, the housing(s) are coupled to the body frame (220). In some embodiments, the motor(s) may be operably coupled to the upper leg portion via gears, chains, belts, etc.

The robotic device may include a plurality of lower leg portions (240). Each lower leg portion may be coupled to an upper leg portion. Each lower leg portion may include a lower leg structural member (241) having a first end (242) and a second end (243). The first end may be rotatably coupled to the second end (233) of the upper leg structural member (231) to form a knee joint (160).

A contact element, such as a passive second wheel (244), may be rotatably coupled to the first end (242) of the lower leg structural member (241). As used herein, the term “passive wheel” is intended to refer to a wheel that is not coupled to any component (e.g., a motor, etc.) that would actively control the rotation of the wheel. In some embodiments, a first wheel may have a larger diameter than a passive second wheel. In some embodiments, a passive second wheel may have a larger diameter than a first wheel. In some embodiments, a passive second wheel may have a diameter equal to the diameter of a first wheel.

A contact element, such as a foot (126) or a passive wheel, may be coupled to the lower leg structural member (241) at the second end (243).

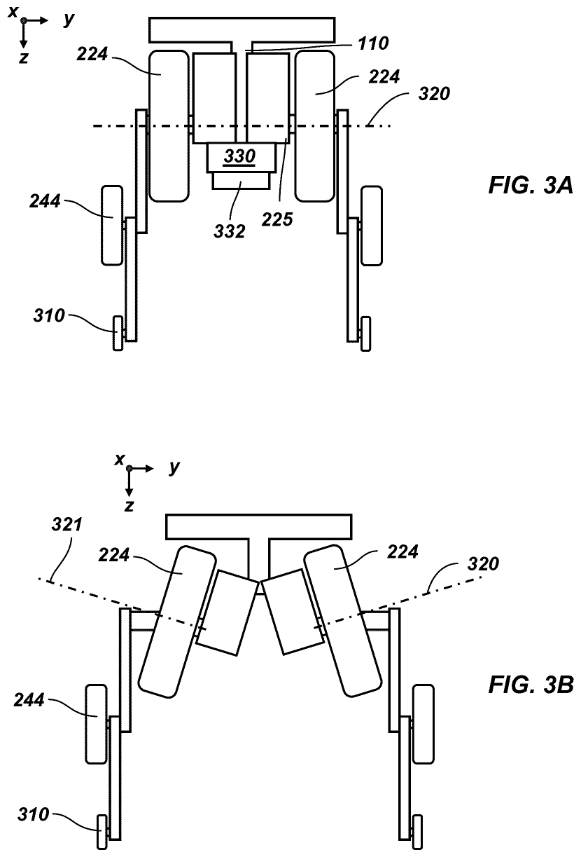

In some embodiments, each first motor may be configured to independently control the rotation of its first wheel around a same first axis (not shown in FIG. 2). In FIG. 2, the first wheel of the left side and the first wheel of the right side are aligned in parallel so both wheels rotate around a same axis. This can be understood in view of FIG. 3A, where a front view of a “standing” robotic device can be seen, with each first wheel (224) parallel to each other, such that both wheels rotate around an axis (here, axis (320)).

Conversely, in some embodiments, each first motor may be configured to independently control the rotation of its first wheel, where each first wheel rotates around a different axis. The different axes may be coplanar and parallel, but different (e.g., one wheel positioned ahead of another, or both wheels turned to the left or right). The different axes may be coplanar but non-parallel (e.g., in FIG. 3B, the first wheels (224) from FIG. 3A are shown as having been reoriented around the x-axis, such that the axis (320) around which one first wheel itself spins (to provide locomotion) is oriented in a different direction from the axis (321) around which the other first wheel itself spins). The different axes may be non-coplanar (not shown), such as if both first wheels (224) from FIG. 3B were also reoriented around the z-axis instead of just the x-axis.

Referring to FIG. 3A, in some embodiments, the robotic device may include one or more inertial stabilizers (330) coupled to the main body and independently actuated through an additional motor (332). Various inertial stabilizers are commercially available, and such devices are well understood in the art. As will be understood, the exact location may vary based on the needs of the robotic device. In some embodiments, the inertial stabilizers are disposed between the first wheel(s) of the device. In some embodiments, a plurality of inertial stabilizers are present. In some embodiments, the first wheel(s) are disposed between at least two inertial stabilizers.

In some embodiments, at least one first wheel may be configured to operate, while not in contact with a ground surface, as an inertial stabilizer, for example, by rotating in particular directions at particular speeds. In some embodiments, the robotic device may be free of discrete inertial stabilizers, and only the first wheel(s) are used to function as inertial stabilizers. In some embodiments, the robotic device may utilize discrete inertial stabilizers in addition to occasionally utilizing the first wheel(s) as inertial stabilizers.

Referring again to FIG. 2, each second motor (234) may be configured to independently control a rotational position of its upper leg structural member (231) relative to the body frame (220). For example, the second motor (234) may be operably coupled to a belt (250). The belt may be coupled to a pulley (251) or gear coupled to the first end (232) of the upper leg structural member (231). When the motor causes the belt to move forward or backward, the upper leg structural member will rotate around a “hip” joint or pivot point (252) at the first end of the upper leg structural member.

Each third motor (235) may be configured to independently control a rotational position of its lower leg structural member (241) relative to its corresponding upper leg (e.g., upper leg structural member (231)). In some embodiments, the axis of rotation of the third motor may be coaxial with the pivot point (252) of the upper leg structural member. In some embodiments, the third motor may be operably coupled to a belt (253). The belt may be coupled to a pulley (254) or gear coupled to the first end (242) of the lower leg structural member (241). When the motor causes the belt to move forward or backward, the lower leg structural member will rotate around a “knee” joint or pivot point (255) at the first end of the lower leg structural member. In some embodiments, this pivot point is at the second end (233) of the upper leg structural member (231) and the first end (242) of the lower structural leg member (241).

In some embodiments, each upper leg further includes a first belt and pulley coupling the second motor to its upper leg structural member and a second belt and pulley coupling the third motor to its lower leg structural member.

While FIG. 2 defines only upper and lower leg structural members, in some embodiments, additional leg segments may be desirable. As additional structural members are incorporated, it is understood that additional motors, belts, gears, etc., could readily be implemented to control those leg segments as disclosed herein.

In FIG. 2, the first wheel and passive second wheel are shown as non-coplanar. Here, a first wheel (224) is disposed closer to the centerline of the robotic device than the passive second wheel (244) (in the y-direction, the second and third motors are disposed between the first wheel and the passive second wheel). However, in some embodiments, the first wheel and the second passive wheel may be coplanar.

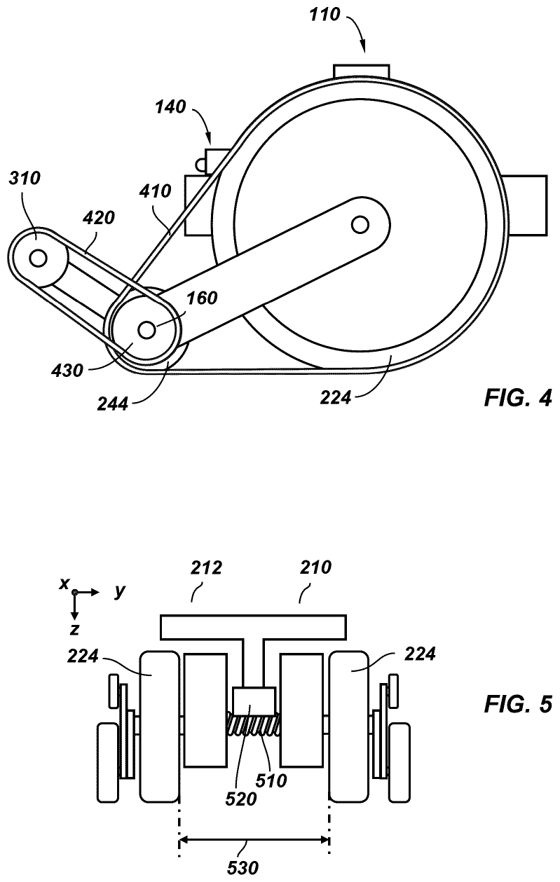

Referring to FIG. 4, in some embodiments, where the first wheel (224) and the passive second wheel (244) may be coplanar, a first track (410) may be run between the first wheel and the passive second wheel. In some embodiments, the foot may be a passive third wheel (310). The robotic device may include a second track (420) attached between the passive third wheel (310) and an additional wheel (430) that is on a same rotational axis and parallel to the passive second wheel (244) at the knee joint (160). The additional wheel (430) may be coaxial with the passive second wheel (244). In some embodiments, parallel wheels at the knee joint (here, passive second wheel (244) and additional wheel (430) may be coupled such that the first track (410) and second track (420) can be driven simultaneously. In some embodiments, the track(s) may be driven simultaneously by the same motor (e.g., the first motor).

The embodiments in FIGS. 1, 2, and 4 depict embodiments where the wheels and legs rotate about parallel axes and are capable of continuous rotation. Continuous rotation here is defined as rotation about a single axis without angular bounds. The wheels and legs in these embodiments may rotate without self-collision in any configuration.

In various embodiments, the mobile robotic device may be configured to operate in a variety of hybrid contact configurations. That is—the robotic device may be configured to operate regardless of which—if any—contact elements may or may not be in contact with anything. In some embodiments, the robotic device may be configured to operate with at most six contact elements in contact with a ground surface at any point in time. In some embodiments, the robotic device may be configured to operate with more than six contact elements in contact with a ground surface at any point in time. In some embodiments, the robotic device may be configured to operate with any subset of its wheels and feet in contact with a ground surface, another robot surface (e.g., a surface of the robot itself, or an adjacent robot), and/or an environment surface (e.g., any feature or object of the environment other than the ground surface). In some embodiments, the mobile robotic device may be configured to operate with any subset of its wheels, tracks, and/or feet in contact with a ground surface, another robot surface, and/or an environment surface.

In certain embodiments, the mobile robotic device may be configured to dynamically transition from a first contact configuration (e.g., driving on two wheels) to a second contact configuration (e.g., climbing steps with feet and two wheels in contact with stair surfaces).

In some embodiments, a distance (530) between (or separating) the first wheel (224) on the left side (210) of the main body and the first wheel on the right side (212) of the main body may be fixed. Referring to FIG. 5, a distance (530) between the first wheel (224) on the left side (210) of the main body and the first wheel on the right side (212) of the main body may be adjustable. Those skilled in the art will readily understand there are numerous ways to accomplish the adjusting of distance between the wheels; any such technique may be used. Non-limiting examples include, utilizing a worm screw (510) coupled to a motor (520) may be controlled such that when the worm screw turns in a first direction, the distance (530) between the first wheel(s) increases, and when the worm screw turns in a second direction, the distance between the first wheel(s) decreases. Alternatively (not shown), actuators may be coupled to the body frame of the left and right sides and may be controlled to cause the entire left and right portions of the robot to separate. Actuators may additionally control the angle between the left and right sides. As used herein, the term ‘actuator’ refers to a device designed to convert an input energy form (such as electrical, hydraulic, or pneumatic) into mechanical motion. This motion can be linear or rotary, enabling the actuator to control a system or mechanism by moving or controlling a mechanism or system.

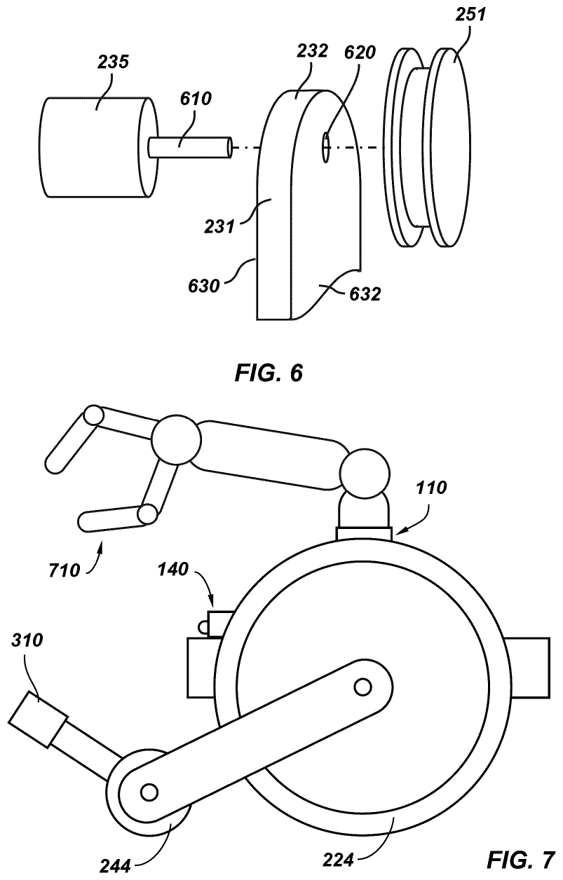

Referring to FIG. 6, in some embodiments, a third motor may be disposed on a first side (630) of an upper leg structural member (231). A drive shaft (610) of each third motor (235) may extend through an opening (620) at the first end (232) of each upper leg structural member to a pulley (251) disposed on a second side (632) of the upper leg structural member. The pulley may drive the rotation of a lower leg structural member (see, e.g., FIG. 2).

Referring to FIG. 7, in some embodiments, the robotic device may include one or more manipulators (710) coupled to the body frame or main body (110)). In some embodiments, the robotic device may be free of manipulators. In some embodiments, the robotic device may include only a single manipulator. In some embodiments, the robotic device may include a plurality of manipulators.

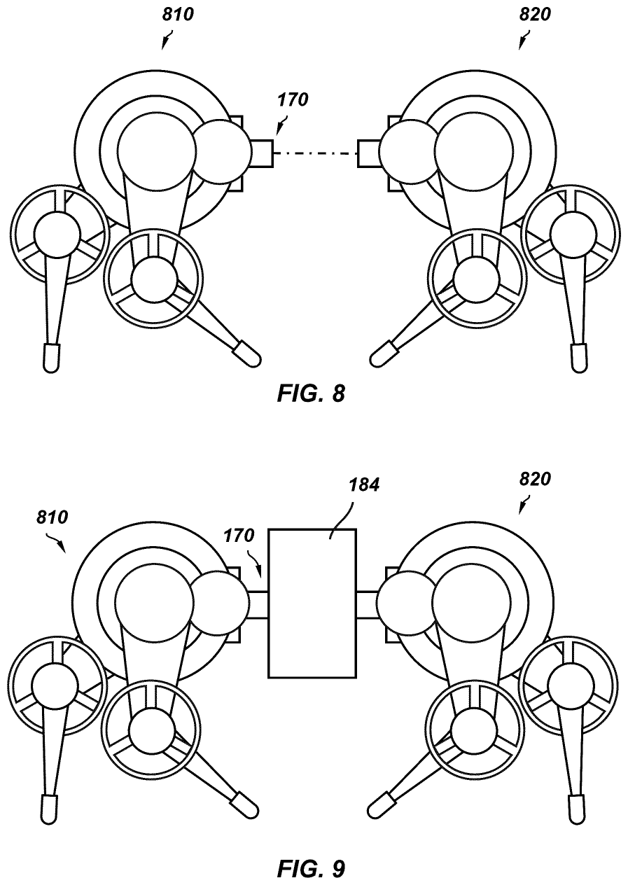

The attachment point (170) may be configured in a variety of ways. Referring to FIG. 8, in certain embodiments, the attachment point (170) of a first robotic device (810) may be configured to attach to an adjacent robot (e.g., second robotic device (820)). This may occur at an attachment point of the second robot. In some embodiments, each robot may include a single attachment point. In some embodiments, at least one robot more may include two or more attachment points. With multiple attachment points, multiple robots can be attached together. In some embodiments, 2 robots are attached together. In some embodiments, 3 robots are attached together. In some embodiments, 4 or more robots are attached together.

As noted previously, the attachment points may be configured to receive a payload. As seen in FIG. 1, that may be a payload disposed on “top” of a robotic device. Referring to FIG. 9, the payload (184) may be disposed between a first robot (e.g., first robotic device (810)) and an adjacent robot (e.g., second robotic device (820)). In some embodiments, the payload may be directly couplable to the attachment point (e.g., mechanically or magnetically directly held at the attachment point). In some embodiments, the payload may be indirectly couplable to the attachment point (e.g., on a shelf or in a basket that is coupled to the attachment point).

In various aspects, the mobile robotic device may include a central actuator operably coupled to the main body. The central actuator may be configured to perform various tasks, such as recharging onboard batteries, providing torque to leg portions, etc. The central actuator may be a combustion engine (such as an internal combustion engine). The central actuator may be an electric motor. The central actuator may be a fuel cell.

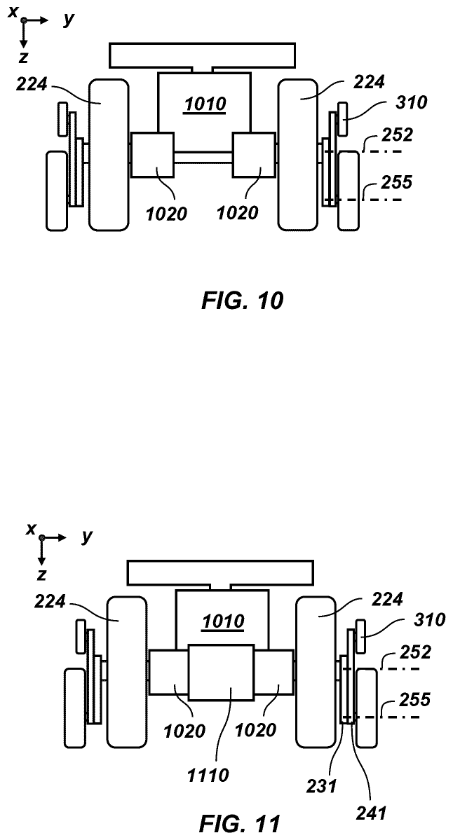

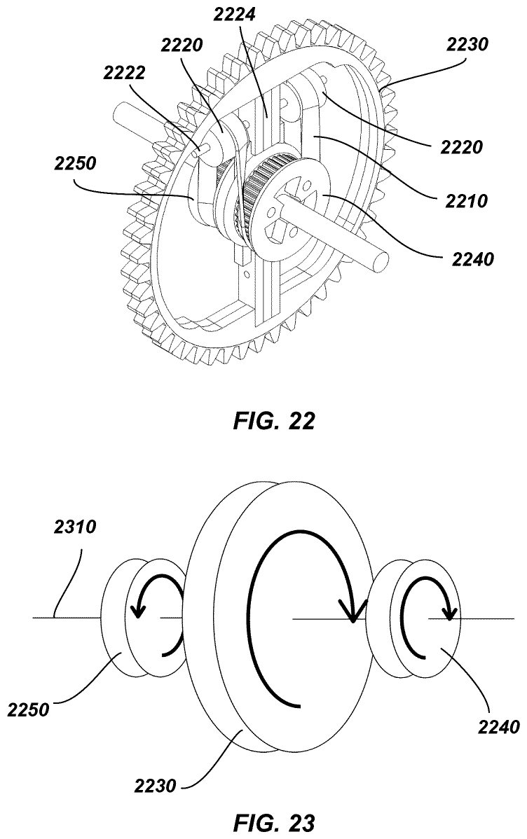

Referring to FIG. 10, the central actuator (1010) may be located onboard the mobile robotic device. The robotic device may include one or more differentials (1020) configured to split torque to multiple joints (here, the joints are indicated by the axis of rotation at the joints, or pivot points, such as pivot point (252) forming a “hip” joint or a pivot point (255) forming a “knee” joint. An embodiment of the differential is provided in FIG. 22. The mobile robotic device may additionally be configured to utilize both an onboard actuator and receive external torque for central actuation.

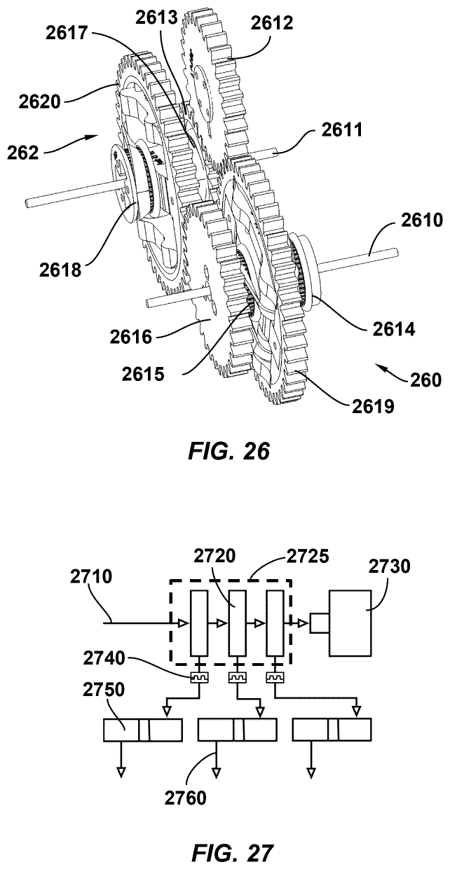

Referring to FIG. 11, the robotic device may include a device for controlling the magnitude and rotational direction of an output from a constant rotational input (1110) operably coupled to wheels (e.g., first wheel (224)), legs (including, e.g., upper leg structural member (231) and/or lower leg structural member (241), and/or tracks. A torque vectoring mechanism depicted in FIG. 26 is an embodiment of such a device. A schematic for central actuation utilizing differentials and torque vectoring mechanisms is provided in FIG. 27. The torque vectoring device operates like a mechanical H-bridge electronic circuit, by using torque instead of voltage to control the magnitude and direction of a rotational output.

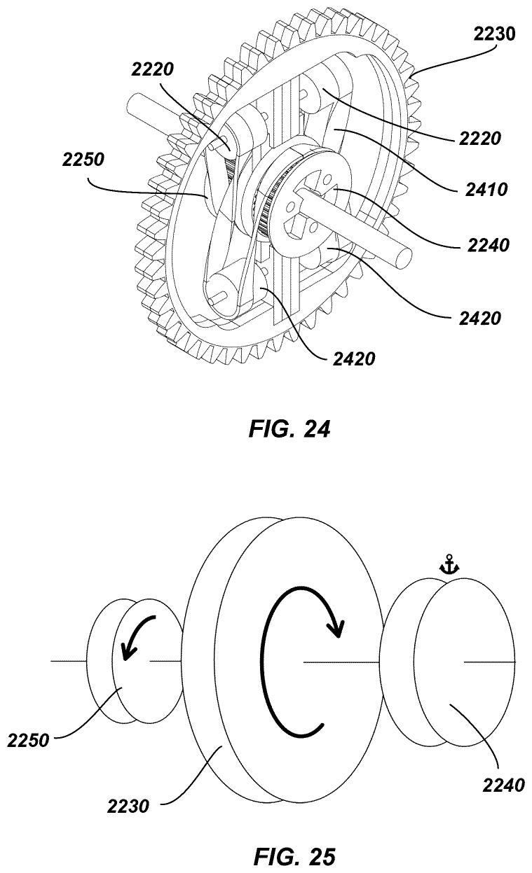

In some embodiments, both torque vectoring mechanisms and one or more differentials are utilized. In some embodiments, only torque vectoring mechanisms are utilized. In some embodiments, only differentials are utilized. In some embodiments, one or more speed reducers, provided in FIG. 24, are utilized. In some embodiments, no speed reducers are utilized.

In some embodiments, the central actuator may be configured to charge an onboard battery. This may be done by, e.g., back-driving an electric motor (2730). Such techniques for charging batteries are well understood in the art.

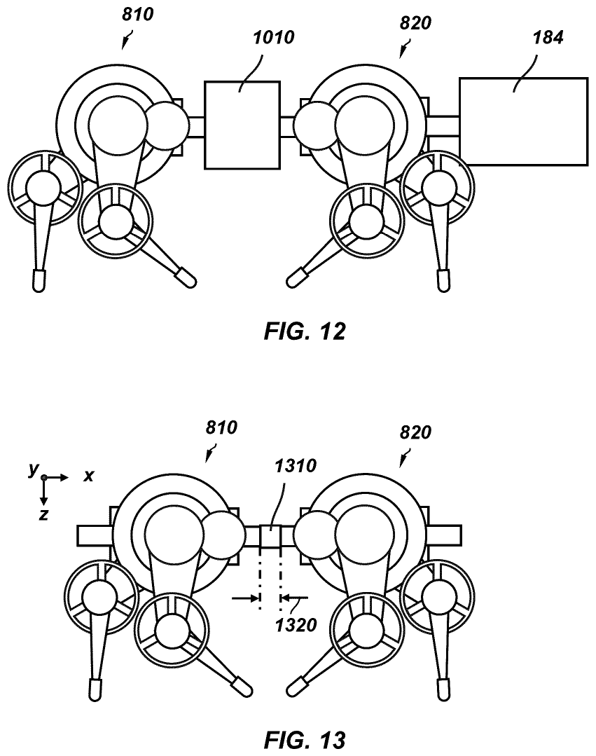

Referring to FIG. 12, in some embodiments, a central actuator (1010) may be disposed between two robots (here, between first robotic device (810) and second robotic device (820)), while a payload (184) may be operably couplable to an attachment point of only one of the robots (here, second robotic device (820).

As implied previously, in various aspects, a mobile robotic system may be provided. The mobile robotic system may include a plurality of mobile robot devices as disclosed herein. The robotic device may be mechanically coupled together. Referring to FIG. 13, in some embodiments, the body frame of each adjacent mobile robot device may be indirectly coupled (e.g., via a coupler (1310)). The body frame of each adjacent mobile robot device may be separated in a first direction (here, the x-direction) by at least a predetermined minimum distance (1320). The coupler may additionally permit rotation, either passive or actuated, about any or all of the x, y, and z axes.

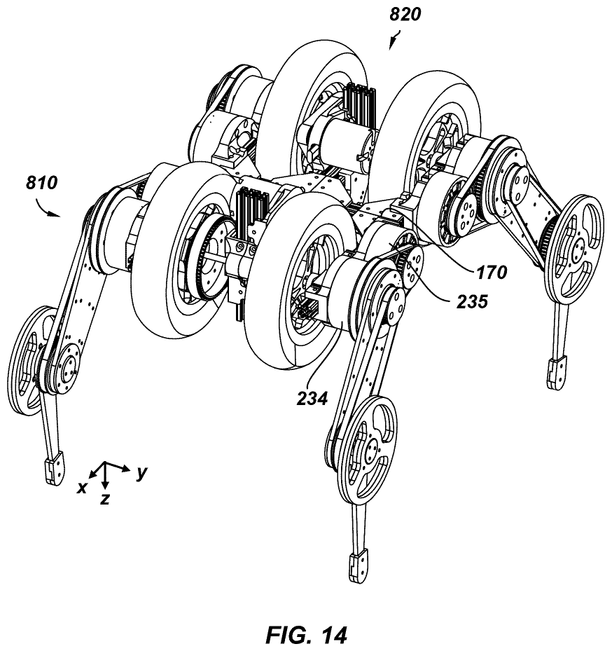

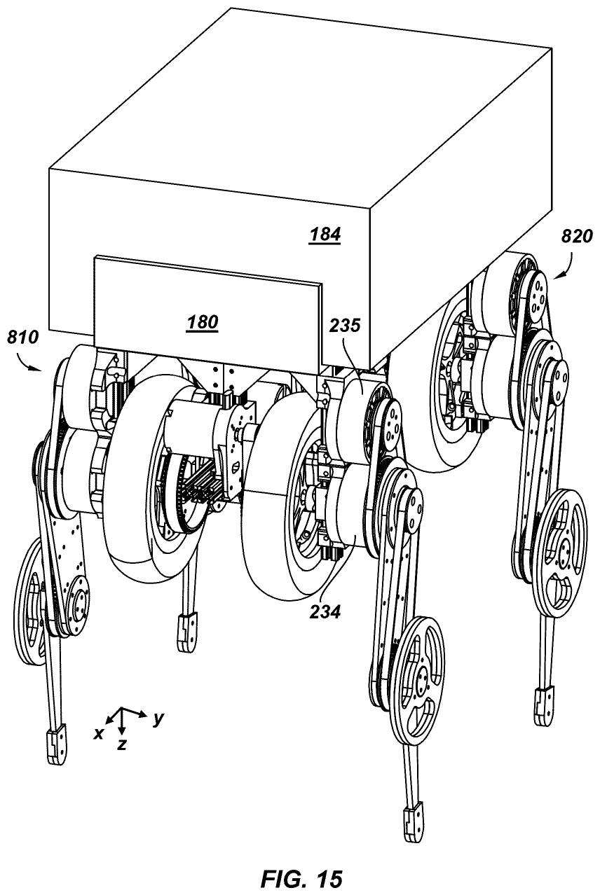

Variations of these approaches can be seen in FIGS. 14 and 15. In FIG. 14, a first robotic device (810) may be mechanically coupled to a second robotic device (820) at an attachment point (170). Any appropriate means for coupling the robots may be utilized. In some embodiments, a coupler may be utilized. In some embodiments, slots and tabs at the attachment point may be configured to interact to couple the robotic devices together. In some embodiments, the robotic devices are removably coupled together. The attachment mechanism may be actuated to enable coupling and decoupling during operation. In some embodiments, the robotic devices are permanently coupled together. In FIG. 15, the robotic devices are shown as having been rotated from the arrangement in FIG. 14. For example, the second motor (234) and third motor (235) are aligned in the z-direction, while in FIG. 14, the second motor and third motor are aligned in the x-direction. The robotic devices in FIG. 15 are coupled together via a payload platform (180), on which a payload (184) is provided. In some embodiments, the payload platform may be adjustable (for example, with actuators, etc.) to provide a force on the payload, allowing the payload to be fixed in place while on the platform and the force is being applied.

As described previously, the system may include various components coupled to the main body of at least one of the robotic devices, such as a payload, a sensor, a manipulator, or a combination thereof.

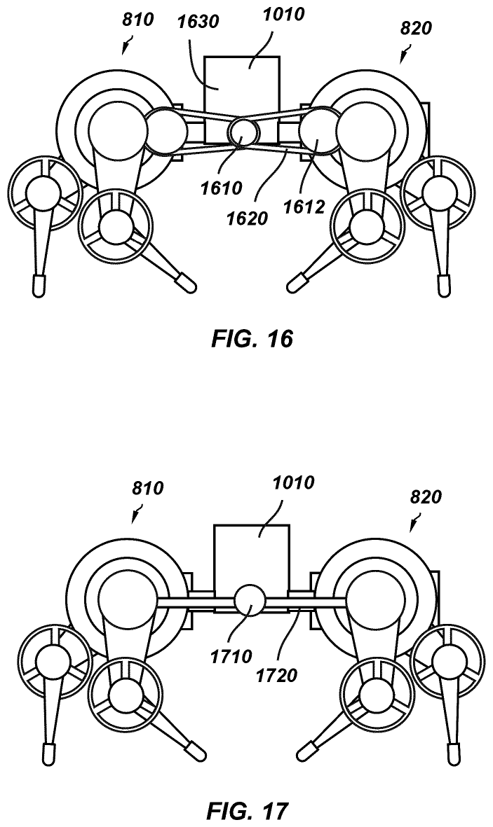

Referring to FIG. 16, in some embodiments, each mobile robot device may be linked to a common actuator (1010) via a mechanical interface on a common surface (1630). In FIG. 16, the mechanical interface is shown as a pulley system (1610). The pulley system (1610) is coupled to one or more pulleys (1612) on each robotic device via, e.g., a belt (1620) or chain. In some embodiments, the pulley system may be a gear system.

Referring to FIG. 17, in some embodiments, the common actuator (1010) is disposed external to each mobile robot device (here, first robotic device (810) and second robotic device (820). Each mobile robot device may be driven by the common actuator. In some embodiments, the system may utilize a differential (1710) coupled to one or more axles (1720) to split torque to multiple robots.

As noted previously, the common actuator may be used to perform various tasks for the robotic system, such as providing joint torques and charging at least one battery while the mobile robotic system is in transit.

In various aspects, a system for controlling a mobile robot may be provided. The system may include at least one processing unit. The processing unit(s) may be configured to control the position and/or rotation of each of a plurality of contact elements. The processing unit(s) may be configured to collectively perform various tasks.

As disclosed herein, processing unit(s) may be configured to encode discrete modes of contact statuses for each of the plurality of contact elements a robotic device may have.

The processing units may be configured to encode hybrid dynamic modes of contact statuses for each of the contact elements. The processing unit(s) may be configured to determine at least one specific time at which guard conditions are met, resulting in transitions between discrete mode encodings.

The processing unit(s) may be configured to construct dynamical models for hybrid dynamic modes of the system at run time by procedurally integrating appropriate equations of motion and kinodynamic constraints into forward dynamics. When discrete mode transitions arise, this may include updating discrete mode encodings and applying continuous state reset mappings. The processing unit(s) may additionally compute Jacobians of the forward dynamics. The processing unit(s) may be configured to compute forward dynamics and Jacobians of the system.

The processing unit(s) may be configured to simulate possible future robot hybrid trajectories. The processing unit(s) may be configured to control the robot to follow a planned trajectory by causing at least the first contact element to spatially move relative to the second contact element based on the trajectory.

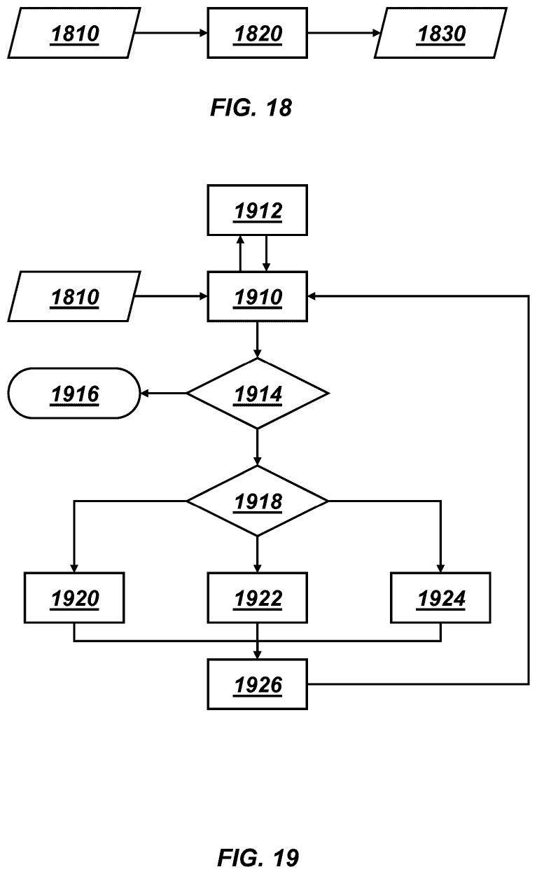

A flowchart of computing forward dynamics and Jacobians can be seen in FIG. 18. There, the method is broadly shown as including receiving (1810) or retrieving inputs, computing (1820) various components of the equations of motion and Jacobians of the dynamics, and outputting (1830) results.

The inputs may include a robot's continuous state consisting of generalized positions and velocities of the system: x(t)=[q(t), dq(t)]. The inputs may include a discrete mode encoding H(t). The inputs may include torques τ(t). The inputs may include a stepsize dt. The inputs may include the surrounding environment S(t). The inputs may include the robot's physical parameters P.

After receiving or retrieving the inputs, processing unit(s) may compute a mass matrix M (q, P). Processing unit(s) may compute a force matrix F(q, dq, τ, S, P). This particular embodiment uses Kane's Method to construct the robotic manipulator equations. Processing unit(s) may compute a position constraint matrix h(q, H). Processing unit(s) may compute a velocity constraint matrix A(q, H). Processing unit(s) may compute an acceleration constraint matrix dA(q, dq, H). Processing unit(s) may compute associated continuous state and input Jacobians. Calls to precomputed functions generate these matrices at runtime for the particular discrete mode, configuration, and input parameters of the system. The processing unit(s) may construct a constrained manipulator equation, solve for the time derivative of the continuous state, dx(t), and compute the continuous state and input Jacobians Jₓdx(t), J_{τ}dx(t).

FIG. 19 shows a flowchart for a single simulation step: x(t)->x(t+dt).

The process again begins with receiving (1810) or retrieving the necessary inputs. The method may then include using a numerical integration algorithm (1910) to obtain x(t+dt). For a Forward Euler step, only dx(t) is required. If a Fifth-order Runge-Kutta (RK45) method is used, this may require computing dx(t+a) for multiple a values. The algorithm (1912) is the one shown in FIG. 18. For all a values, the method may include determining a dynamics step with dt=a, and returning (e.g., from algorithm (1912)) dx(t+a) and associated Jacobians.

Once x(t+dt) has been computed, the method may include checking (1914) for discrete mode transitions that occurred between x(t) and x(t+dt).

If no such conditions (guard conditions) were encountered, the method may include stopping the computations by accepting (1916) x(t+dt) (or x(t+a), see below) and the input discrete mode H(t) as the next hybrid state in the trajectory, and accepting all Jacobian matrices.

However, if a guard condition arose, the method may include determining the type of guard (1918).

For example, if the guard condition is a tangent force to a surface, edge, or corner crossing a static friction threshold, implicitly signaling a transition between sliding and static contact modes, the method may include using (1920) a root-finding algorithm to find the first time t+a* when the friction of contact body equals the static friction threshold. The contact type will change between static and sliding at that time.

If the guard condition is a contact element entering contact with a surface, edge, or corner, the method may include using (1922) a root-finding algorithm to find the first time t+a* when the contact element makes contact with the surface, edge, or corner. The contact element will enter contact at that time.

If the guard condition is a force perpendicular to a surface, edge, or corner becoming positive, implicitly signaling that a contact element leaves contact, or, if a contact element leaves a boundary, the method may include using (1924) a root-finding algorithm to backtrack to the first time t+a* when the perpendicular force becomes zero, or when the contact element exists a surface, edge, or point-boundary. The contact element will leave contact at that time.

The method may then include updating (1926) the discrete mode encoding and performing any necessary continuous state resets (such as setting the z velocity of a foot to zero at contact).

The process is then rerun to compute x(t+a*). The process is rerun with x(t)->x(t+a*), H(t)->H(t+a*), and dt->dt−a*. The Jacobians are computed accordingly. Once no guard conditions are met, terminate, accepting x(t+a), H(t), and the Jacobians. The algorithm performs checks for Zeno behavior, where infinitely many discrete mode transitions occur in finite time, and handles such occurrences accordingly. Therefore, the algorithm will compute x(t+dt) in a finite number of iterations. Further guard conditions may be introduced in addition to (1920), (1922), and (1924). These may require additional reset maps in (1926). This algorithmic description follows the existing body of work in hybrid systems theory but provides a way to compute and construct equations of motion and Jacobians of hybrid dynamics scalably and efficiently at runtime.

The disclosed approach provides for hybrid wheeled-legged locomotion. A single instance of the disclosed approach can traverse the environment in wheeled, tracked, and ambulatory modes. Existing legged robots excel at traversing uneven terrains such as curbs and stairs but lack agility and robustness. Wheeled robots excel at quickly traveling over flat surfaces but cannot overcome complex terrains. The disclosed approach can smoothly change between locomotion strategies of driving and walking. Further, the disclosed approach is capable of strategies that simultaneously combine wheeled and legged locomotion, such as crawling and vaulting over curbs or obstacles.

While hybrid robots capable of driving and walking exist, the wheels are generally positioned at the distal tip (“foot”) of robot limbs. In various disclosed embodiments, differentially driven wheels are affixed to the body of the robot, and passive wheels are positioned at the knee joint of the robot to provide an additional contact surface for stability and maneuverability.

Embodiments of the disclosed approach may include passive wheels to assist in stability. Such an arrangement may include a passive wheel at a knee joint to provide additional stability in driving modes and extend hybrid locomotion modes.

The disclosed approach allows for supermodular configurations. Multiple instances of the disclosed approach may operate collaboratively to transport payloads exceeding the carrying capacity of a single instance. Instances of the disclosed approach may be attached to a common surface or to other instances for cooperative locomotion and payload transportation. Coupling multiple instances permits cooperative locomotion strategies such as quadrupedal locomotion. This approach offers improvements in walking stability compared to single-instance ambulation. This approach additionally provides improvements in carrying capacity relative to the number of coupled instances.

In addition to supermodular configurations, the present disclosure also provides for submodular configurations. In a preferred embodiment, the robot may be composed of two removably coupled halves—a left side (210) and a right side (212). Submodularity enables interchanging parts. Limbs may be swapped for different lengths, and wheels may be swapped for track sprockets to adjust locomotion modalities. This additionally results in a variable track width for adjusting tradeoffs between stability, load distribution, and robot size, and additionally reduces the complexity of manufacturing and maintenance. The disclosed approach may additionally include electrical, mechanical, and electromechanical interface layers for the attachment of payloads, sensors, tools, manipulators, and additional submodules.

Payload attachments. Existing sidewalk robots typically include a body cavity for secure payload storage. This places a restriction on payload size and requires a user or a system to remove the payload from the robot. The disclosed approach attaches a payload to an external surface or module of the robot. This enables autonomous payload attachment and detachment. The payload attachment module may additionally be used for coupling multiple robots to one another or to a common surface.

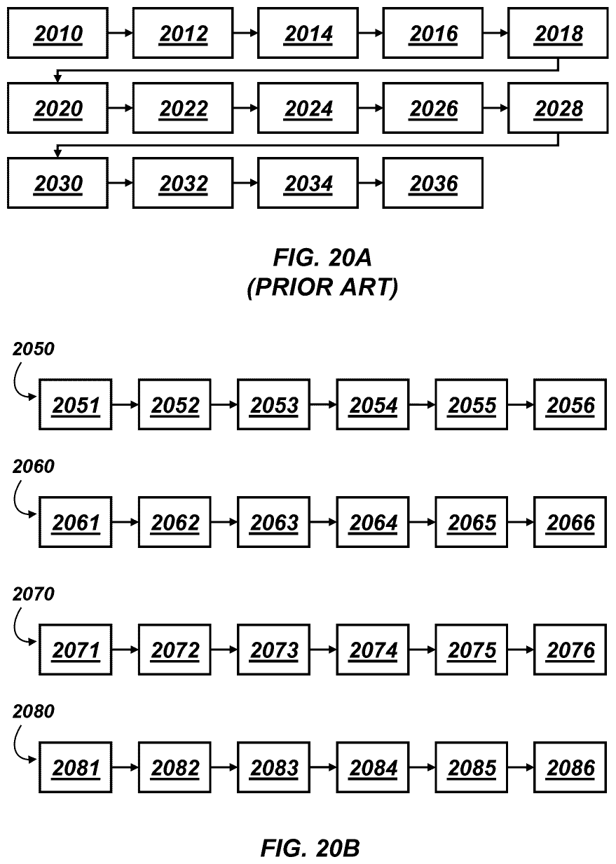

These robotic devices may be used in various applications, such as warehousing, delivery, etc. For example, consider a typical human package delivery process, where a human driver may need to deliver three packages. A flowchart of this can be seen in FIG. 20A, where the overall sequence may include driving (2010) to a stop, parking (2012) the delivery vehicle, exiting (2014) the vehicle, loading (2016) packages, traversing (2018, 2022, 2026) to the dropoff location and dropping (2020, 2024, 2028) off and verifying the dropoff for each of the three packages, the traversing (2030) back to the delivery vehicle, entering (2032) the van, starting (2034) the van, and driving (2036) to the next stop.

Compare that process to one utilizing three embodiments of a robotic device as disclosed herein. A flowchart of this can be seen in FIG. 20B, which illustrates tasks executed by robots and the driver simultaneously. There, the process (2050) for the human driver contains six steps—driving (2051) to a stop, parking (2052) the delivery vehicle, exiting (2053) the vehicle, loading (2054) packages for the subsequent stop in a hopper, then entering (2055) the van, and driving (2056) to the next stop. The process (2060, 2070, 2080) for each of the three robotic devices is identical—loading (2061, 2071, 2081) one or more packages from the hopper, exiting (2062, 2072, 2082) the van, traversing (2063, 2073, 2083) to the dropoff location, dropping off and verifying dropoff of a package (2064, 2074, 2084), traversing (2065, 2075, 2085) back to the van, and entering the van (2066, 2076, 2086). Indeed, in some delivery environments, the driver may not even need to park or exit the vehicle—if packages are preloaded for a given delivery path, the robots merely need to exit, drop off, and return, while the driver just follows a predetermined delivery path. Parallel task execution enabled by the disclosed device may significantly improve the efficiency of curbside delivery. Additionally, it may substantially reduce the workload of delivery drivers.

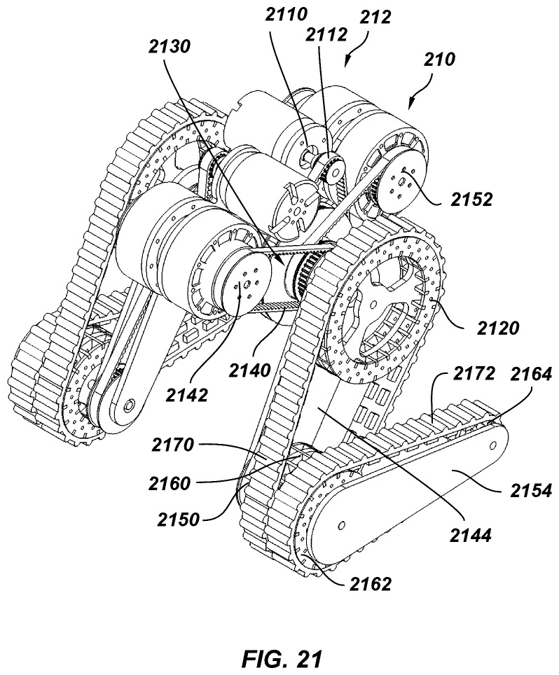

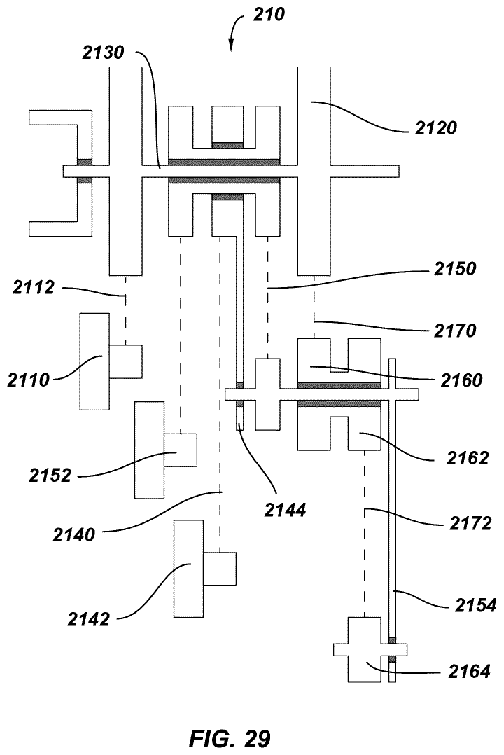

Referring to FIG. 21, an embodiment of a robotic device in a track-legged configuration described in FIG. 4 is shown. The two halves or sides—a left side (210) and a right side (212) are shown. Both sides may be removably coupled together. A motor (2110) on the left side of the device may be used to drive a wheel (2120) on the same side via a concentric shaft (2130). The motor (2110) may be operably coupled to the concentric shaft via a belt (2112). The belt (2140) and pulley (2142) are configured to rotate the upper leg structural member (2144). The belt (2150) and pulley (2152) are configured to rotate the lower leg structural member (2154). Passive wheels (2160, 2162, 2164) are shown. However, a first passive wheel (2160) and a second passive wheel (2162) may be coupled (directly or indirectly) such that the two tracks (here, the first track (2170) and second track (2172)) are driven by the same motor (2110). This allows a lower leg segment to be removably coupled to an upper leg segment. FIG. 29 illustrates the concentric shafts utilized in this embodiment of a track-legged robot.

Referring briefly to an embodiment of a differential depicted in FIG. 22, a belt (2210) may loop over idlers (2220), with teeth (if present) facing outwards while the belt interacts with the idlers. The idlers may rotate around a shaft (2222), which may pass through one or more supports (2224) configured to hold the shaft in place relative to the gears of the differential. The supports (2224) are coupled to a rotary element (2230). Pulleys (2240) and (2250) and the rotary element (2230) rotate on a bearing. When the rotary element (2230) is locked, a second pulley (2250) rotates in the opposite direction of the first input pulley (2240). The rotary element rotates in the same direction as the first pulley when the second pulley is locked. Torque is split between the rotary element and the second pulley, constituting a differential.

This is illustrated in FIG. 23, where an input torque is applied to the first pulley (2240). The input torque is split between the rotary element (2230) rotating in the same direction as first pulley (2240), and second pulley (2250), rotating in the opposite direction of (2240). This allows the mechanism to act as a differential, with outputs at (2230) and (2250) rotating in opposite directions.

This design enables stacking differentials in a sequence, permitting the construction of multiple output (and/or multiple input) differentials. For example, in FIG. 23, subsequent differentials may be added on the same axis (2310) (e.g., to the left of the second pulley (2250)), such that a first pulley (e.g., a duplicate of first pulley (2240)) of the second differential is coupled to the second pulley (2250) of the first differential. As will be understood, various options for coupling differentials together are envisioned. For example, subsequent differentials may also be coupled with the pulleys (2240) and (2250) or rotary element (2230) on a separate axis.

This differential is similar to the epicyclical differential, as the rotary inputs and outputs may be aligned on the same axis. This embodiment reduces complexity but introduces elasticity and hysteresis with inclusion of the belt.

Additionally, referring to FIG. 24, it is possible to insert another set of idlers (2420) and wrap belt (2410) around both sets of idlers (2220) and (2420). In this pattern, the first pulley (2240) and the second pulley (2250) rotate in the same direction. This mechanism no longer acts as a differential but as a speed reducer with fixed gear ratios determined by pulleys (2240) and (2220). Let pulley (2240) have n teeth and pulley (2250) have m teeth. In the case where the rotary element (2230) is rotationally fixed, pulleys (2240) and (2250) rotate in the same direction with a fixed n: m ratio. In the case where pulley (2240) is rotationally fixed and an input torque is applied to (2230), pulley (2250) rotates with a fixed 1:(m−n)/m ratio between the rotation of (2230), and the output pulley (2250). When n<m, the second pulley (2250) rotates in the same direction as the rotary element (2230). When n>m, the second pulley (2250) rotates in the opposite direction as the rotary element (2230). When n=m, the output pulley does not rotate. This mechanism may be utilized in the reverse configuration as an overdrive. This can be seen in FIG. 25. (2250) rotates in the opposite direction as (2230) since the radius of (2250) is smaller than the radius of (2240). A torque input may be applied to (2230) to cause (2250) to rotate. Alternatively, a torque input may be applied to (2250) to cause (2230) to rotate.

For example, with a two-loop system where pulley (2240) is rotationally fixed, if pulley (2240) has 56 teeth, and pulley (2250) has 54 teeth, a −54:2 ratio between rotations of (2230) and (2250) occurs. If a torque input is applied to the rotation element (2230) such that it rotates clockwise, the output pulley will rotate counterclockwise 27 times slower. However, if instead the pulley (2240) has 54 teeth and the output pulley has 56 teeth, a 56:2 ratio between rotations of (2230) and (2250) occurs, and the torque applied to the rotary element (2230) will now cause the pulley (2250) to rotate clockwise as well.

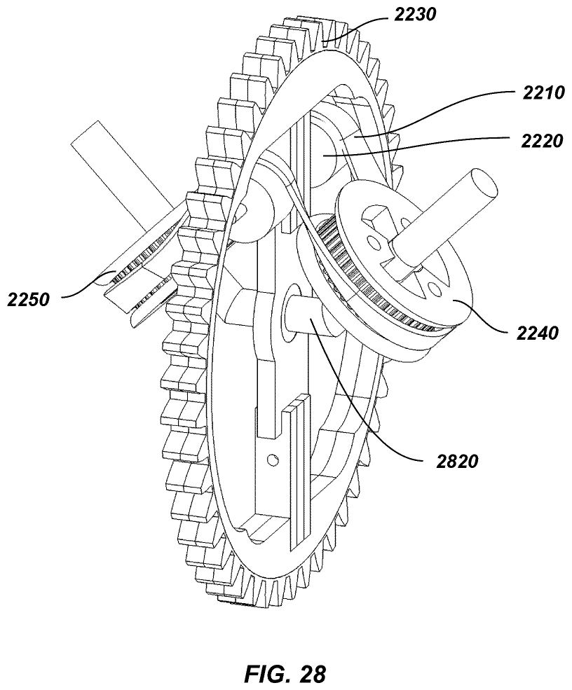

Referring to FIG. 28, the pulleys of the differential and speed reducer may rotate about separate axes with the introduction of a modified shaft (2820). Pulleys (2240) and (2250) and the rotary element (2230) rotate on a bearing. In this embodiment, the mechanism behaves similarly to the one shown in FIG. 22. The first and second pulleys are angled to route power transmission.

Referring to FIG. 26, two instances of the differential shown in FIG. 22, such as a first differential (260) and a second differential (262), may be configured with additional gears to create a torque-vectoring mechanism for controlling output torque and output rotation direction of pulley (2618) using actuators. This mechanism utilizes two parallel shafts, (2610) and (2611). Gear (2613) is coupled to pulley (2617), and gear (2616) is coupled to pulley (2615). Intermediate gear (2612) is idle, coupling gears (2619) and (2613). Torque input is applied to the pulley (2614). The torque output is on the pulley (2618). In this arrangement, applying resistive “brake torques” to the gears alters the torque output of the mechanism and can control the direction of the output at pulley (2618). This is similar to brake torque vectoring on cars but extends the concept to additionally control rotation direction. Such brake torques may be produced by low torque actuators in arrangements well-understood in the art. For instance, applying a high resistive torque on any gear(s) in (2416) and (2420) would result in the output (2618) rotating in the opposite direction of the input. When a high resistive torque is applied to any gear(s) in (2612), (2613), and (2619), the output (2618) would rotate in the same direction as the input. The resistive torque may be applied with a servo motor and brake pads, or the back electromotive force of a motor. Continuously varying the resistive torque on both sets of gears enables output rotation in both directions as well as zero rotation. The exact proportions depend on gear and pulley ratios of the system. Additionally, subsequent differentials, speed reducers, and torque-vectoring double-differential mechanisms may be coupled to any of (2614, 2615, 2616, 2617, 2618, 2619, 2620) to extend the system in a modular manner. While inefficient, this torque-vectoring double-differential mechanism is a core enabling component of the central actuation design paradigm.

Instances of the speed reducer depicted in FIG. 24 may be utilized to facilitate efficient back electromotive force braking and regenerative braking. An overdrive may be attached to the input (2614), and a speed reducer may be attached to the output (2618). This would raise the rotation speed of the gears and decrease torque, enabling low-power motors attached to the gears or pulleys to control the magnitude and direction of the output using back electromotive force. This pattern is key to enabling central actuation, by using a powerful central driving motor and routing torque to joints with low-power, compact, and cost-effective control motors.

Referring to FIG. 27, a schematic of central actuation is shown. Torque input (2710) may originate from any appropriate source for providing torque, such as a motor onboard the robotic device, or from an external source. Differentials (2720) split the input torque. A generator or torque limiter (2730) provides a base resistance torque to the sequence of differentials. This terminates the sequence of differentials. A generator may additionally be utilized to generate electricity to, e.g., charge a battery.

Instances of the torque-vectoring double-differential (2750) control the magnitude and direction of each torque output (2760), which may drive wheels, legs, tracks, or other mechanisms. The torque vectoring devices may be configured as aforementioned with an overdrive at the input and a speed reducer at the output.

A clutch mechanism (2740) may be coupled to, e.g., each differential (2720). Such clutch mechanisms can enable or disable torque propagation to the torque vectoring device. When disabled, it causes the coupled differential to pass through torque to other differentials in (2725). When enabled, it propagates torque to the torque vectoring device and the subsequent output. This enables addition and removal of modular joints from a centrally actuated system.

Instances of the torque reducer shown in FIG. 24 may be incorporated at any part of the system.

The disclosed mechanisms provide for the supermodular “centralized actuation” of robots. Multiple instances of the disclosed robot approach may be linked to a common actuator via a mechanical interface on the common surface. This permits multiple instances of the robot to be driven via an external actuator. Further, embodiments may consist of multiple robots, which may propel the embodiment. For instance, a carrier vehicle may be composed of multiple instances of the disclosed robotic device, which serve as the wheels of the vehicle. During transit, the robots may be actuated and charged via a mechanical connection to an internal combustion engine. Upon reaching a destination, the robot may separate from the chassis of the carrier to complete tasks. The robot would switch to actuation powered by its own battery and motor(s). This would be a multi-echelon embodiment of the system depicted in FIG. 27, where a series of differentials (2720) and clutched (2740) onboard the carrier vehicle would drive multiple robots, each of which has the structure depicted in FIG. 27, with the option of switching between external and on-board sources of input torque (2710).

Embodiments of the robot may incorporate partial or full central actuation whereby joint torques for multiple joints may originate from a single actuator. This may be realized by, e.g., utilizing differentials to split torque to multiple joints. Variations in the rotation direction, torque, and rotation at the joint may be achieved with a torque vectoring mechanism or a continuously variable transmission (CVT). The central actuator may be located onboard the robot, external to the robot, or by both an internal and an external actuator in a framework similar to that in hybrid-electric vehicles. Similarly, the external actuator may charge the robot's onboard battery by driving the onboard electric motor as a generator (2730) in a regenerative braking configuration. This enables, e.g., the robotic device to “charge in transit” as disclosed herein.

The present disclosure also allows for submodular centralized actuation which may occur onboard the robot. A central drive shaft composed of multiple coupled differentials is capable of splitting torque to multiple outputs. Differentials without an output device may be locked with clutches to pass through torque. This enables joints to be added and removed from the robot. Additionally, the number of differentials is easily adjusted by simply adding or removing from the stack(2725). Central actuation enables highly modular robots with wheels, legs, and joints that can be easily interchanged, repositioned, added, or removed.

In various aspects, a method for controlling a robot, including a hybrid dynamical simulation procedure, may be provided. The method may include (a) receiving inputs defining a robot hybrid state at time t (comprised by a discrete mode at time t and a continuous state at time t), robot physical parameters, the aggregate effect of generalized forces and external physical forces acting on the robot's continuous states torque at time t, a stepsize (dt), and an environment surrounding the robot. The environment surrounding the robot may be a characterization of the environment. This may include a map of an environment surrounding the robot, where the map may include, e.g., geometric structures and mechanical properties of the environment. The method may include (b) utilizing inputs to construct equations of motion at runtime for the robot's hybrid dynamics. The method may include (c) numerically integrating the equations of motion (“flow”) within the discrete robot mode at time t to obtain a continuous robot state at a subsequent timestep: t+dt. The method may include (d) determining if a discrete mode transition (“jump”) occurred between time t and t+dt by checking for guard conditions occurring between the continuous robot state at time t and the continuous robot state at time t+dt.

If no guard condition exists, the method may include accepting the continuous robot state at time t+dt and the same discrete robot mode from time t as jointly forming the next hybrid state in the simulated trajectory at time t+dt. The method may include controlling the robot so as to satisfy the next robot hybrid state in the trajectory.

If a guard condition exists, the method may include additional steps. Such additional steps may include using a root-finding algorithm to find a first time (t+a*) the guard condition occurred. The method may include generating an updated robot hybrid state after the “jump” by appropriately switching the discrete mode and performing any necessary continuous state resets. The method may include repeating steps (b)-(d) with the updated robot hybrid state after the discrete transition at time t+a*, updated inputs at time t+a*, and dt=dt−a*. Once no guard conditions are met, the method may include accepting the robot continuous state at time t+a* and the discrete mode from time t.

In various aspects, using the root-finding algorithm may include several steps. In some embodiments, if a tangent force to a surface, edge, or corner crosses a static friction threshold, the method may include using a root-finding algorithm to find the first time (t+a*) when a friction of contact body equals the static friction threshold. In some embodiments, if a contact element enters contact with a surface, edge, or point, the method may include using a root-finding algorithm to backtrack to the first time (t+a*) when a contact element makes contact with a surface, edge, or corner.

In some embodiments, if a force acting perpendicular to a contact interface—whether it be a surface, edge, or corner—and transitions from being a repelling force, typically represented by the normal force in classical mechanics, to an attracting force or if a contact interface leaves a boundary, using a root-finding algorithm to backtrack to the first time (t+a*) when the force perpendicular to the surface, edge, or corner becomes zero or when the contact point exits a surface, edge, or point boundary.

In certain embodiments, the robot can be operated using solely forward dynamics computations. This allows for the simulation of numerous potential trajectories, from which the best trajectory is selected based on a predefined criteria. Specifically, ‘best“’ in this context refers to the trajectory that incurs the lowest cost, as determined by a heuristic cost function. This approach enables efficient and effective decision-making in the robot's control system, optimizing its movements according to the cost function's parameters. In certain embodiments, the method involves computing the Jacobians of the equations of motion at runtime. This computational step allows the robot's control system to be informed by both the computed hybrid states and the Jacobians, enhancing its responsiveness and accuracy. Furthermore, in some implementations, the control strategy may rely exclusively on the Jacobians for determining the robot's movements.

In various aspects, a mechanism, such as that shown in FIG. 22, may be provided. The mechanism may include two pulleys operably coupled by a belt. The mechanism may include a free rotating rotary element (sometimes referred to as an intermediate rotary element), with at least one shaft and at least one idler such that the belt is passed over the at least one shaft at least once.

The intermediate rotary element may be configured to transmit torque to subsequent components (e.g., a component operably coupled to the intermediate rotary element, such as a gear, pulley, etc.). For example, in FIG. 22, the rotary element has gear teeth. Similarly, each pulley may be configured to transmit torque to other components. As one example, the rotary element and/or the pulleys may be coupled to a power transmission mechanism.

In some embodiments, the mechanism may act as a differential. Referring to FIG. 22, in some embodiments, the belt may be looped once over one or more of the idlers. For example, in FIG. 22, the belt (2210) is shown as being looped “once”, in that it passes over only a single set of idlers (which could be a single large idler)—here, the belt (2210) passes over two idlers (2220) of the rotary element (2230), one on either side of support(s) (2224). A first pulley (2240) may receive a torque input in a first direction and may split the torque, as a differential, between the second pulley (2250) and the rotary element, such that the rotary element rotates in the first direction, a second pulley rotates opposite the first direction.

In some embodiments, the mechanism may act as a torque converter. Referring to FIG. 24, in some embodiments, the belt may be looped twice over one or more idlers of the rotary element. As seen in FIG. 24, the belt (2410) may is looped “twice”, such that it passes over two sets of idlers (each of which could be a single large idler)—here, the belt (2410) passes over a first set of idlers (2220) and a second set of idlers (2420). As seen, belt (2410) passes over the top of first pulley (2240), under a second set of idlers (2420), over a first set of idlers (2220), then under a second pulley (2250), then back over the top of the first set of idlers (2220), under the second set of idlers (2420), and back to the starting point on top of first pulley (2240).

As will be understood, in some embodiments, the belt may be looped more than two times over idlers—such as by incorporating additional idlers between the two pulleys, such that the belt is operably coupled to the additional idlers as it passes between the two pulleys.

A first pulley (2240) may receive a torque input in a first direction. The rotary element (2230) may be rotationally fixed. A second pulley (2250) may rotate in the first direction.

In some embodiments, this may perform as a simple torque converter with n. m gear reduction (n and m being the number of teeth on or the radius of the first and second pulley, respectively), when the rotary element is fixed.

Specifically, in some embodiments, a first pulley (2240) may be rotationally fixed. The rotary element (2230) may receive an input torque in a first direction. A second pulley (2250) may rotate opposite the first direction.

In embodiments, when the first pulley is fixed, a high speed reduction or amplification is possible with a m:m-n ratio. Specifically, a first pulley (2240) may be rotationally fixed. A second pulley may receive an input torque in a first direction. The rotary element may rotate opposite the first direction.

The pulleys may be on a same axis (see, e.g., FIGS. 22, 24). The pulleys may be on separate axes. The separate axes may be parallel to each other. The separate axes may be non-parallel with each other (see, e.g., FIG. 28).

The idlers may be on a same axis. The idlers may be on separate axes. The separate axes may be parallel to each other. The separate axes may be non-parallel with each other (e.g., idlers (2220) could be in a v-shape, etc.).

In various aspects, a system may be provided. The system may include a plurality of mechanisms as disclosed herein, mechanically coupled together. For example, multiple differentials and torque reducers can be coupled to form larger systems for central actuation or other applications. As one specific example, multiple differentials can be “stacked” to form a multi-input, multi-output differential.

In various aspects, the plurality of mechanisms may include a first differential mechanically coupled to a second differential. A rotary element of the first differential may be coupled to a first pulley of the second differential. The second pulley of the first differential may be coupled to the rotary element of the second differential. Actuators may be configured to control the magnitude and direction of the torque at a second pulley of the second differential. An embodiment of this may be seen in FIG. 26. From a constant rotational input, this mechanism can adjust the magnitude and direction of the output.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications, and the like.

Although various embodiments that incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

1. A mobile robotic device, comprising:
a main body operably coupled to a plurality of contact elements, each contact element being a wheel, track, or foot; and
at least one processing unit configured to control positioning and/or rotation of each of the plurality of contact elements, the at least one processing unit configured to, collectively:
process perception and odometry data;
encode hybrid dynamic modes with contact statuses for each of the plurality of contact elements;
construct a dynamical model for each discrete mode at runtime by constructing appropriate equations of motion and constraint equations and, when discrete mode transitions arise, updating discrete mode encodings and applying continuous state reset mappings;
simulate possible future hybrid robot trajectories; and
control the robot to follow a planned trajectory.

2. The mobile robotic device of claim 1, wherein:
the main body has a left side and a right side, each side including:
a body frame;
a first wheel operably coupled to the body frame, each first wheel being one of the plurality of contact elements; and
a first motor operably coupled to the first wheel;
a plurality of upper legs, each upper leg removably coupled to the body frame of the left side or the right side, each upper leg including:
an upper leg structural member having a first end and a second end, the upper leg structural member being rotatably coupled to the body frame at the first end; and
a second motor and a third motor operably coupled to the upper leg structural member;
a plurality of lower legs, each lower leg coupled to one of the plurality of upper legs, each lower leg including:
a lower leg structural member having a first end and a second end, the first end of the lower leg structural member being rotatably coupled to the second end of the upper leg structural member to form a knee joint;
a passive second wheel rotatably coupled to the first end of the lower leg structural member, each passive second wheel being one of the plurality of contact elements; and
a foot or smaller passive wheel coupled to the second end of the lower leg structural member, each foot or smaller passive wheel being one of the plurality of contact elements;
wherein each first motor is configured to independently control the rotation of its first wheel around a same first axis;
wherein each second motor is configured to independently control a rotational position of its upper leg structural member relative to the body frame; and
wherein each third motor is configured to independently control a rotational position of its lower leg structural member relative to its corresponding upper leg.

3. The mobile robotic device of claim 2, wherein the first wheel and the passive second wheel are coplanar, and where a first track runs between the first wheel and the passive second wheel.

4. The mobile robotic device of claim 3, wherein the foot or smaller passive wheel is a smaller passive wheel, and wherein the main body further comprises a second track attached between the smaller passive wheel and a wheel that is on a same rotational axis and parallel to the passive second wheel at the knee joint.

5. The mobile robotic device of claim 4, wherein parallel wheels at the knee joint are coupled such that the first track and second track can be driven simultaneously.

6. The mobile robotic device of claim 2, wherein each upper leg further includes a first belt and pulley coupling the second motor to its upper leg structural member, and a second belt and pulley coupling the third motor to its lower leg structural member.

7. The mobile robotic device of claim 2, wherein a distance between the first wheel on the left side of the main body and the first wheel on the right side of the main body is adjustable.

8. The mobile robotic device of claim 2, wherein a drive shaft of each third motor extends through an opening at the first end of each upper leg structural member to a pulley that drives the rotation of the lower leg structural member.

9. The mobile robotic device of claim 2, wherein the mobile robotic device includes circuitry coupled to the main body, the circuitry connecting at least one processing unit, a memory, and a non-transitory computer-readable storage medium.

10. The mobile robotic device of claim 2, wherein the mobile robotic device includes a battery removably coupled to the mobile robotic device.

11. The mobile robotic device of claim 2,
wherein the mobile robotic device is configured to operate in a variety of contact configurations, the variety of contact configurations consisting of any subset of its wheels and feet in contact with a ground surface, another robot surface, or an environment surface; or
wherein the mobile robotic device is configured to operate in a variety of contact configurations, the variety of contact configurations consisting of any subset of its wheels, tracks, and/or feet in contact with a ground surface, another robot surface, and/or an environment surface.

12-14. (canceled)

15. The mobile robotic device of claim 2, wherein the mobile robotic device is able to dynamically transition from a first contact configuration to a second contact configuration.

16. The mobile robotic device of claim 2, further comprising:
one or more inertial stabilizers coupled to the main body and independently actuated through an additional motor;
one or more sensors coupled to the main body;
one or more manipulators coupled to the main body;
or a combination thereof.

17. The mobile robotic device of claim 2, wherein at least one first wheel is configured to operate, while not in contact with a ground surface, as an inertial stabilizer.

18-19. (canceled)

20. The mobile robotic device of claim 2, wherein the main body defines an attachment point.

21-22. (canceled)

23. The mobile robotic device of claim 1, further comprising a central actuator operably coupled to the main body, the central actuator comprising a combustion engine or an electric motor.

24-27. (canceled)

28. A mobile robotic system, comprising:
a plurality of mobile robotic devices of claim 1, mechanically coupled together.

29-33. (canceled)

34. The mobile robotic system of claim 28, wherein each mobile robot device is linked to a common actuator via a mechanic interface on a common surface.

35-37. (canceled)

38. A system for controlling a mobile robot, comprising:
at least one processing unit configured to control positioning and/or rotation of each a plurality of contact elements, the plurality of contact elements including a first contact element and a second contact element, the at least one processing unit configured to, collectively:
encode hybrid dynamic modes of contact statuses for each of the plurality of contact elements;
determine at least one specific time at which guard conditions are met, resulting in transitions between discrete mode encodings;
construct dynamical models for hybrid dynamic modes of the system at runtime by procedurally integrating appropriate equations of motion and kinodynamic constraints into forward dynamics;
simulate possible future robot hybrid trajectories;
plan a trajectory based on the hybrid dynamical models; and
control the robot to follow a planned trajectory by causing at least the first contact element to spatially move relative to the second contact element based on the trajectory.

39. A method for controlling a robot, including a hybrid dynamical simulation procedure, comprising:
a. receiving inputs defining a robot hybrid state at time t, robot physical parameters, an aggregate effect of generalized forces and external physical forces acting on the robot at time t, a stepsize (dt), and a map of an environment surrounding the robot, the robot hybrid state at time t comprising a discrete mode at time t and a continuous state at time t, the map comprising geometric structures and mechanical properties of the environment;
b. utilizing inputs to construct equations of motion at runtime for the robot hybrid dynamics;
c. numerically integrating the equations of motion (“flow”) within the discrete robot mode at time t to obtain a continuous robot state at a subsequent timestep: t+dt; and
d. determining if a discrete mode transition (“jump”) occurred between time t and t+dt by checking for guard conditions occurring between the continuous robot state at time t and the continuous robot state at time t+dt.

40-55. (canceled)
